(19) United States
(12) Patent Application Publication
(10) Pub. No.: US 2022/0298813 A1
(43) Pub. Date: Sep. 22, 2022

(54) REBAR TYING TOOL

(71) Applicant: MAKITA CORPORATION, Anjo-shi, Aichi (JP)

(72) Inventors: Shunta MIZUNO, Anjo-shi (JP); Yuta ASAKURA, Anjo-shi (JP)

(73) Assignee: MAKITA CORPORATION, Anjo-shi, Aichi (JP)

(21) Appl. No.: 17/632,314

(22) PCT Filed: Aug. 18, 2020
(86) PCT No.: PCT/JP2020/031173

§ 371 Date: Feb. 2, 2022

(30) Foreign Application Priority Data
Aug. 26, 2019 (JP) 2019-153560

(51) Int. Cl. E04G 21/12; B21F 15/04; B65B 13/28

(52) U.S. Cl. CPC E04G 21/123; B21F 15/04; B65B 13/285

(57) ABSTRACT

A rebar tying tool is configured to tie rebars with a wire. The rebar tying tool may include: a feeding unit, a twisting unit, a grip, an indicator, and a facing surface. The feeding unit may be configured to feed the wire around the rebars. The twisting unit may be configured to twist the wire around the rebars. The grip may be disposed downward than the twisting unit and configured to be gripped by an operator. The indicator may be configured to indicate a status of the rebar tying tool. The facing surface may be disposed in front of the grip and facing the grip. The indicator may be disposed on the facing surface.

### TECHNICAL FIELD

The disclosure herein relates to a rebar tying tool.

### BACKGROUND ART

Japanese Patent Application Publication No. 2017-132003 describes a rebar tying tool, This rebar tying tool is configured to tie rebars using a wire. The rebar tying tool includes a feeding unit, a twisting unit, a grip, a battery receptacle, and an indicator. The feeding unit is configured to feed the wire around the rebars. The twisting unit is configured to twist the wire around the rebars. The grip is disposed downward than the twisting unit and is configured to be gripped by an operator. The battery receptacle is disposed below the grip. The indicator is disposed on an upper surface of the battery receptacle and is configured to indicate a status of the rebar tying tool.

### SUMMARY OF INVENTION

### Technical Problem

In the above rebar tying tool, the indicator is disposed on the upper surface of the battery receptacle. Due to this, upon performing a. tying operation, a hand of the operator gripping the grip overlaps over the indicator. As a result, the indicator becomes hidden by the hand of the operator, and the operator cannot easily visually recognize the indicator. The description herein discloses an art that facilitates an operator to visually recognize an indicator.

### Solution to Technical. Problem.

The present teachings disclose a rebar tying tool, The rebar tying tool is configured to tie rebars with a wire. The rebar tying tool may comprise: a feeding unit; a twisting unit; a grip; an indicator; and a facing surface. The feeding unit is configured to feed the wire around the rebars. The twisting unit is configured to twist the wire around the rebars. The grip is disposed downward than the twisting unit and configured to be gripped by an operator. The indicator is configured to indicate a status of the rebar tying tool. The facing surface is disposed frontward. than the grip and facing the grip. The indicator is disposed on the facing surface.

In the above configuration, when the operator grips the grip upon performing a tying operation, the facing surface is less likely to be hidden by a hand of the operator gripping the grip, and thus the indicator is also less likely to be hidden by the hand of the operator. Further, when the rebar tying tool is tilted, the indicator enters a field of view of the operator. Due to the foregoing, the operator can easily recognize the indicator visually upon performing the tying operation.

Further, a rebar tying tool may comprise: a feeding unit; a. twisting unit; a grip; and an indicator. The feeding unit is configured to feed the wire around the rebars. The twisting unit is configured to twist the wire around the rebars. The grip is disposed downward than the twisting unit and configured to be gripped by an operator. The indicator is configured to indicate a status of the rebar tying tool. The indicator is disposed on a side surface of the grip.

In the above configuration, since the indicator is disposed on a left side surface of the grip, the indicator enters the field of view of the operator when the rebar tying tool is tilted. Due to this, the operator can easily recognize the indicator visually.

### BRIEF DESCRIPTION OF DRAWINGS

FIG. 1 is a perspective view of a rebar tying tool 2 of a first embodiment.

FIG. 2 i.s a side view of the rebar tying tool 2 of the first embodiment in a state having detached a left main body 4a, a left grip 6a, a left battery receptacle 8a, and a cover member 20.

FIG. 3 is a rear view of the rebar tying tool 2 of the first embodiment.

FIG. 4 is a perspective view of a contacting member 66 of the rebar tying tool 2 of the first embodiment.

FIG. 5 is a side view of the rebar tying tool 2 of the first embodiment before the contacting member 66 pivots.

FIG. 6 is a side view of the rebar tying tool 2 of the first mbodiment after the contacting member 66 has pivoted.

FIG. 7 is a side view of a rebar tying tool 2 of a second embodiment.

FIG. 8 is a perspective view of a rebar tying toot 202 of a third embodiment as seen from a rear left upper side.

FIG. 9 is a perspective view of the rebar tying tool 202 of the third embodiment as seen from a front right upper side.

FIG. 10 is a side view showing an internal configuration of the rebar tying tool 202 of the third embodiment.

FIG. 11 is a perspective view of the rebar tying tool 202 of the third embodiment as seen from the front right upper side in a state having detached an auxiliary cover member 226.

FIG. 12 is a cross-sectional view of an accommodating part 210 of the third embodiment.

FIG. 13 is a perspective view of a reel 232, a rotating base 246, and a sensor substrate 242 of the third embodiment.

FIG. 14 is a perspective view of a feeding unit 250 of the third embodiment.

FIG. 15 is a perspective view of an accommodating part 210, a feeding motor 256, a reduction gear unit 258, a feeding part 260, and an operating part 284 of the third embodiment.

FIG. 16 is a cross-sectional view of a vicinity of the operating part 284 of the third embodiment when a lever 286 is in a closed position.

FIG. 17 is a cross-sectional view of a vicinity of a guiding part 262 of the rebar tying tool 202 of the third embodiment.

FIG. 18 is a side view of a cutter unit 252 of the rebar tying tool 202 of the third embodiment showing a state before a first lever member 312 and a second lever member 314 pivot.

FIG. 19 is a side view of the cutter unit 252 of the rebar tying tool 202 of the third embodiment showing a state after the first lever member 312 and the second lever member 314 have pivoted.

FIG. 20 is a perspective view of a twisting unit 254 of the rebar tying tool 202 of the third embodiment.

FIG. 21 is a cross-sectional view of a twisting motor 322, a reduction gear unit 324, and a retaining part 326 of the twisting unit 254 of the rebar tying tool 202 of the third embodiment.

FIG. 22 is a perspective view of a carrier sleeve 336, a clutch plate 338, and a screw shaft 340 of the twisting unit 254 of the rebar tying tool 202 of the third embodiment.

FIG. 23 is a perspective view of a clamp shaft 346 of the twisting unit 254 of the rebar tying tool 202 of the third embodiment.

FIG. 24 is a perspective view of the twisting unit 254 of the rebar tying tool 202 of the third embodiment in a state having a right clamp 348 and a left clamp 350 attached to the clamp shaft 346.

FIG. 25 is a perspective view of the right clamp 348 of the twisting unit 254 of the rebar tying tool 202 of the third embodiment.

FIG. 26 is a perspective view of the left clamp 350 of the twisting unit 254 of the rebar tying tool 202 of the third embodiment.

FIG. 27 is a perspective view of the twisting motor 322, the reduction gear unit 324, and the retaining part 326 of the twisting unit 254 of the rebar tying tool 202 of the third embodiment.

FIG. 28 is a perspective view of a rotation restrictor 328 of the rebar tying tool 202 of the third embodiment.

FIG. 29 is a perspective view of a rebar pusher 456 of the rebar tying tool 202 of the third embodiment.

FIG. 30 is a cross-sectional view of the rebar pusher 456 of the rebar tying tool 202 of the third embodiment.

FIG. 31 is a cross-sectional view of a vicinity of an outer sleeve 344 of the rebar tying tool 202 of the third embodiment.

FIG. 32 is a cross-sectional view of a tensioning process of the rebar tying tool 202 of the third embodiment, in a state where rear ends of rear push rods 494, 498 have entered into recesses 514, 516 of a push plate 476.

FIG. 33 is a cross-sectional view of the rebar tying tool 202 of the third embodiment in a state where the tensioning process is completed.

FIG. 34 is a cross-sectional view of the rebar tying tool 202 of the third embodiment in a state where a twisting process is completed.

### DESCRIPTION OF EMBODIMENTS

In. one or more aspects, a rebar tying tool is configured to tie rebars with a wire. The rebar tying tool may comprise: a feeding unit; a twisting unit; a grip; an indicator; and a facing surface. The feeding unit may be configured to feed the wire around the rebars. The twisting unit may be configured to twist the wire around the rebars. The grip may be disposed downward than the twisting unit and configured to be gripped by an operator. The indicator may be configured to indicate a status of the rebar tying tool. The facing surface may be disposed frontward than the grip and facing the grip. The indicator may be disposed on the facing surface.

In the above configuration, when an operator grips the grip upon performing a tying operation, the facing surface is less likely to be hidden by a hand of the operator gripping the grip, and thus the indicator is also less likely to be hidden by the hand of the operator. Further, when the rebar tying tool is tilted, the indicator enters a field of view of the operator. Due to the foregoing, the operator can easily recognize the indicator visually.

In one or more aspects, the rebar tying tool may further comprise an adjusting unit configured to adjust a tying condition of the rebar tying tool. The adjusting unit may be disposed on the facing surface.

In the above configuration, the operator can operate the adjusting unit while seeing the indicator in a state of gripping the grip.

in one or more aspects, the facing surface may comprise a first facing surface overlapping with the grip and a second facing surface not overlapping with the grip when the rebar tying tool is viewed from behind. At least a part of the indicator may he disposed on the second facing surface.

In the above configuration, since at least a part of the indicator is disposed on the second facing surface, the indicator may enter a field of view of the operator even when the rebar tying tool is not tilted. Due to this, it becomes easier for the operator to visually recognize the indicator.

In one or more aspects, the facing surface may be disposed on a rear portion of a first accommodating part configured to accommodate a reel around which the wire is wound.

in the above configuration, since the first accommodating part is disposed in a space in front of the grip, a size of a part of the rebar tying tool upward than the grip can be reduced, and the rear portion of the first accommodating part can be utilized as the facing surface on Which the indicator is disposed.

In one or more aspects, the rebar tying tool may further comprise: a controller electrically connected to the indicator. The indicator may be disposed downward. than the twisting unit a.n.d disposed upward than. the controller.

in the above configuration, the indicator and the controller are connected by a cable.

Since the indicator is disposed downward than the twisting unit and upward than the controller, the indicator and the controller can be connected without extending the cable through the twisting unit. Due to this, an arrangement of the cable connecting the indicator and the controller can be suppressed from becoming complicated.

In one or more aspects, the rebar tying tool may further comprise: a facing part disposed downward than the twisting unit, wherein the facing surface is disposed on the facing part; a second accommodating part disposed downward than the grip and configured to accommodate the controller; and a first connecting cable that electrically connects the indicator and the controller. The facing part may be coupled to the second accommodating part via a coupler. The first connecting cable may extend from the facing part to the second accommodating part via the coupler.

In the above configuration, the first connecting cable extending from the facing part to the second accommodating part can be arranged without extending it through the twisting unit. Thus, the first. connecting cable can be suppressed from interfering with the twisting unit.

In one or more aspects, the feeding unit may comprise a feeding motor. The rebar tying tool may further comprise a second connecting cable that electrically connects the feeding motor and the controller. The feeding unit may be disposed downward than the twisting unit. The second connecting cable may extend from the feeding motor to the second accommodating part via the coupler.

In the above configuration, the second connecting cable extending from the feeding motor to the second accommodating part can be arranged without extending it through the twisting unit. Thus, the second. connecting cable can be suppressed from interfering with the twisting unit.

In one or more aspects, the rebar tying tool may further comprise: a detecting sensor configured to detect a rotation of a reel around which the wire is wound; and a third connecting cable that electrically connects the detecting sensor and the controller. The detecting sensor may be disposed downward than the twisting unit. The third connecting cable may extend from the detecting sensor to the second accommodating part via the coupler.

In the above configuration, the third connecting cable extending from the detecting sensor to the second accommodating part can be arranged without extending it through the twisting unit. Thus, the third connecting cable can be suppressed from interfering with the twisting unit.

In one or more aspects, a rebar tying tool is configured to tie rebars with a wire. The rebar tying tool may comprise: a feeding unit; a twisting unit; a grip; and an indicator. The feeding unit may be configured to feed the wire around the rebars. The twisting unit may be configured to twist the wire around the rebars. The grip may be disposed downward than the twisting unit and configured to be gripped by an operator. The indicator may be configured to indicate a status of the rebar tying tool. The indicator may be disposed on a side surface of the grip.

In the above configuration, since the indicator is disposed on the side surface of the grip, the indicator enters the field of view of the operator when the rebar tying tool is tilted. Due to this, the operator can easily recognize the indicator visually.

In one or more aspects, the rebar tying tool may further comprise: a trigger and an adjusting unit. The trigger may be configured to drive the feeding unit and the twisting unit based on an operation by the operator. The adjusting unit may be configured to adjust a tying condition of the rebar tying tool. The adjusting unit may be disposed near the trigger.

in the above configuration, since the adjusting unit is disposed near the trigger, the operator can operate both the trigger and the adjusting unit with the hand gripping the grip.

In one or more aspects, the adjusting unit may be disposed near the indicator,

In the above configuration, the operator can operate the adjusting unit while checking the indicator.

In one or more aspects, the rebar tying, tool may further comprise: a trigger lock configured to prohibit an operation of the trigger. The trigger lock may be disposed near the adjusting unit.

in the above configuration, since the trigger lock is disposed near the adjusting unit, the operator can operate the trigger lock with a finger that operates the adjusting unit.

In one or more embodiments, a rebar tying tool may tie rebars with a wire. The rebar tying tool may comprise: a feeding unit configured to feed the wire around the rebars; a twisting unit configured to retain and twist the wire around the rebars; a main body configured to accommodate the feeding unit and the twisting unit; and a contacting member disposed in front of the twisting unit and configured to come into contact with the rebars upon a tying, operation. A contacting position at which the contacting member comes into contact with the rebars and a retaining position at which the twisting unit retains the wire may be configured to move relative to each other in directions separating away from one another in a state where the twisting unit is retaining the wire.

In the above configuration, in the state where the twisting unit is retaining the wire, the wire is pulled when the contacting position and the retaining position move relative to each other in the directions separating away from one another. As a result, the wire can be suppressed from being twisted in a state where the wire is loosened. Due to this, tying force of the wire on the rebars can be increased.

In one or more embodiments, in the state where the twisting unit is retaining the wire, the contacting position may be configured to move frontward with respect to the main body.

In the above configuration, by moving the contacting position frontward with respect to the main body, the contacting position and the retaining position can be moved relative to each other in directions separating away from one another.

In one or more embodiments, the rebar tying tool may further comprise a pushing part configured to push the contacting member frontward with respect to the main body.

In the above configuration, by pushing the contacting member frontward with respect to the main body using the pushing part, the contacting position and the retaining position can be moved relative to each other in directions separating away from one another.

in one or more embodiments, the pushing part may comprise: a first push rod disposed facing the contacting member behind the contacting member and configured to move in a front-rear direction with respect to the main body; a second push. rod disposed facing the first push rod behind the first push rod and configured to move in the front-rear direction with respect to the main body; and a compression spring coupling the first push rod and the second push rod.

In the above configuration, an excessive load can be suppressed from being: applied to the contacting member by contraction of the compression spring, and the rebar tying tool can be suppressed from being damaged.

In one or more embodiments, the pushing part may further comprise a push plate disposed facing the second push rod behind the second push rod and configured to move in the front-rear direction with respect to the main body. The push plate may be configured to move frontward with respect to the main body following a motion of the twisting unit.

In the above configuration, the second push rod moves frontward with respect to the main body by the push plate pushing the second push rod frontward. Due to this, the contacting member can be pushed frontward with respect to the main body following the motion of the twisting unit.

In one or more embodiments, the push plate may comprise a recess into which a rear end of the second push rod enters at a position of the push plate facing the second push rod.

In the above configuration, a position of the second push rod with respect to the push plate is fixed by the rear end of the second push rod entering the recess. Due to this, the second push rod can stably be moved frontward.

In one or more embodiments, the pushing part may further comprise a rod guide configured to guide movements of the first push rod and the second push rod,

In the above configuration, the first push rod and the second push rod move in. the front-rear direction in a state of being guided by the rod guide. Due to this, the first push rod and the second push rod can stably be moved in the front-rear direction.

In one or more embodiments, the contacting member may be supported by the main body pivotably about a pivot axis. The rebar tying tool may further comprise a biasing member configured to bias the contacting member with respect to the main body such that the contacting member pivots rearward in a closing direction with respect to the main body when the contacting member pivoted frontward in an opening direction. with respect to the main body.

In the above configuration, even when the contacting member pivoted frontward in the opening direction, a biasing force by the biasing member is applied to the contacting member, and the contacting member can thereby be returned to a state of being dosed rearward.

In one or more embodiments, the contacting member may comprise: a first contacting part supported by the main body pivotably about a first pivot axis; and a second contacting part disposed separately from the first contacting part and. supported by the main body pivotably about a second pivot axis.

In the above configuration, since the first contacting part and the second contacting part are disposed separately, a load applied from the rebars to the contacting member can be distributed.

In one or more embodiments, in the state where the twisting unit is retaining the wire, the retaining position may be configured to move rearward with respect to the main body.

In the above configuration, by moving the retaining position rearward with respect to the main body, the contacting position and the retaining position can be moved relative to each other in directions separating away from one another.

In one or more embodiments, in the state where the twisting unit is retaining the wire, the contacting position may be configured to move rearward with respect to the main body.

in the above configuration, when the wire is twisted by the twisting unit in a state where the wire is in tight contact with the rebars, the contacting position moves rearward. Due to this, the rebars move rearward relatively with respect to the rebar tying tool, by which tension on the wire is adjusted. As a result, with such a simple configuration, the rebar tying tool can be suppressed from being damaged due to an excessive load being applied to the contacting member and the twisting unit.

In one or more embodiments, the rebar tying tool may further comprise a. pullback unit configured to pull back the wire that is wrapped around the rebus. The contacting position may be configured to move rearward with respect to the main body when the contacting member comes into contact with the rebars while winding the wire.

In the above configuration, when the wire that is wrapped around the rebars is pulled back by the pullback unit, the wire comes into tight contact with the rebars. When the wire around the rebars is further pulled back, the contacting position moves rearward. Due to this, the rebars move relatively rearward with respect to the rebar tying tool. As a result, the tension on the wire is reduced as compared to a case where an interval between the rebus and the twisting unit is maintained constant. Due to this, the rebar tying tool can be suppressed from being damaged due to an excessive load being applied to the contacting member and the twisting unit.

In one or more embodiments, the contacting member may be configured to move rearward together with the rebars with respect to the main body when it comes into contact with the rebars.

In the above configuration, the contacting member moves rearward together with the rebars upon the tying operation. Due to this, a load applied to the contacting member can be reduced as compared to a case in which the contacting member does not move rearward together with the rebars, that is, a case where the contacting position moves rearward due to the contacting member composed for example of an elastic material deforming elastically. As a result, the rebar tying tool can be suppressed from being damaged.

In one or more embodiments, the rebar tying tool may further comprise an elastic member configured to deform elastically as the contacting member moves rearward together with the rebars.

In the above configuration, a load applied to the main body from the rebars through the contacting member can be suppressed by elastic deformation of the elastic member.

In one or more embodiments, the contacting member may comprise: a first contacting part; and a second contacting part disposed apart from the first contacting part. The first contacting part and the; second contacting part may come into contact with the rebars upon the tying operation.

In the above configuration, the rebars come into contact with. the contacting member at two points upon the tying operation. Due to this, the rebars can stably be brought into contact with the contacting member as compared to a case in which the rebars come into contact with the contacting member at one point.

In one or more embodiments, one end of the first contacting part on a rebars side and one end of the second contacting part on the rebars side may be curved in directions separating away from one another.

In the above configuration, the rebars come into contact with these curved portions of the contacting member. Due to this, durability of the contacting member can be improved.

In one or more embodiments, the first contacting part and the second contacting part may each extend in a. separating direction of the first contacting part and the second contacting part and a direction perpendicularly intersecting the front-rear direction.

In the above configuration, the rebars can be suppressed from separating away from the contacting member even when a position of the rebars is displaced in the separating directions and the direction perpendicularly intersecting the front-rear direction.

In one or more embodiments, the contacting member may further comprise a coupler coupling the first contacting part and the second contacting part.

In the above configuration, strength of the contacting member can be improved, Further, since the first contacting part and the second contacting part move integrally, an orientation of the rebar tying tool can be suppressed from being changed upon the tying operation.

### First Embodiment

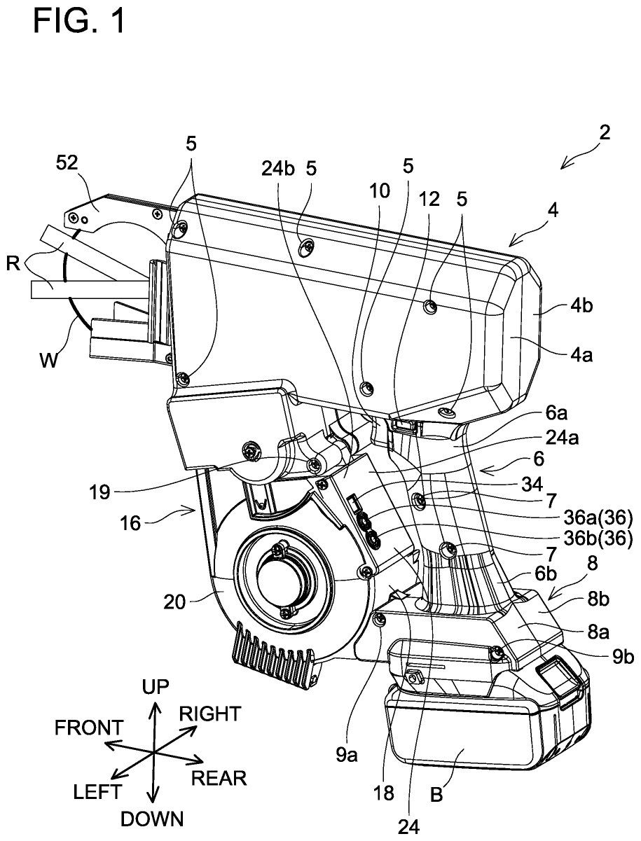

A rebar tying tool 2 of a first embodiment will be described with reference to FIGS. 1 to 6. The rebar tying tool 2 is configured to tie a wire W around a plurality of rebars R. For example, the rebar tying tool 2 is configured to tie the wire W around narrow rebars R having a diameter of 16 mm or less, or wide rebars R having a diameter greater than 1.6 min (such as the diameter of 25 mm or 32 rnm). A diameter of the wire W may for example be a value within a range of 0.5 mm to 2.0 mm.

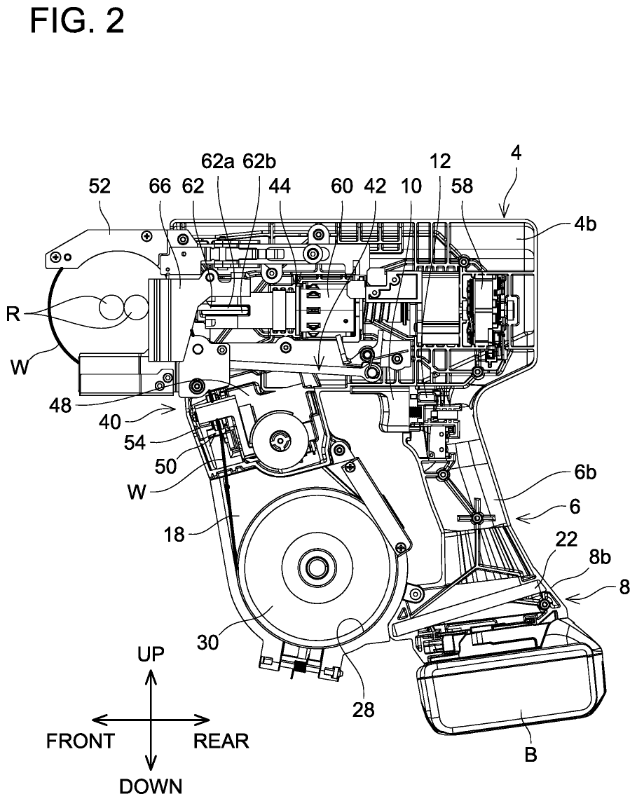

As shown in FIG. 1, the rebar tying tool 2 comprises a main body 4, a grip 6, a battery receptacle 8, a controller 22 (see FIG. 2), and an accommodating part 16. The main body 4 comprises a left main body 4a and a right main body 4b. The left main body 4a composes an outer shape of a left half of the main body 4. The right main body 4b composes an outer shape of a right half of the main body 4. The left main body 4a and the right main body 4b are fixed by screws 5. in the present embodiment, a longitudinal direction of a twisting unit 44 to be described later (see FIG. 2) will be termed a front-rear direction, a direction perpendicularly intersecting the front-rear direction will be termed an up-down direction, and a direction perpendicularly intersecting the front-rear direction and the up-down direction will be termed a left-right direction.

The grip 6 is a member for an operator to grip. The grip 6 is arranged at a rear lower portion of the main body 4. The grip 6 is integrated with the main body 4. The grip 6 comprises a left grip 6a and a right grip 6a. The left grip 6a composes an outer shape of a left half of the grip 6. The right grip 6a composes an outer shape of a right half of the grip 6. The left grip 6a and the right grip 6a are fixed by screws 7.

A trigger 10 is disposed at a. front upper portion of the grip 6. When the trigger 10 is pressed in, a tying operation of tying the rebars R with the wire W is started.

A trigger lock 12 is attached to an upper left side surface of the grip 6. The trigger lock 12 is disposed near a connecting position of the main body 4 and the grip 6. The trigger lock 12 is disposed near the trigger 10. The trigger lock 12 is configured to move between an allowing position and a prohibiting position. When the trigger lock 12 is in the allowing position, a press-in operation on the trigger 10 is allowed. When the trigger lock 12 is pressed in by the operator and moves from the allowing position to the prohibiting position, the trigger lock 12 comes into contact with a stopper (not shown) of the trigger 10. Due to this, the press-in operation on the trigger 10 is thereby prohibited.

The battery receptacle 8 is disposed below the grip 6. The battery receptacle 8 is integrated with the grip 6. The battery receptacle 8 comprises a left battery receptacle 8a and a right battery receptacle 8b. The left battery receptacle 8a composes an outer shape of a left half of the battery receptacle 8. The right battery receptacle 8b composes an outer shape of a right half of the battery receptacle 8. The left battery receptacle 8a and the right battery receptacle 8b are fixed by screws 9a, 9b.

A battery B is detachably attached to the battery receptacle 8. The battery B may for example be a lithium ion battery. As shown in FIG. 2, the battery receptacle 8 accommodates the controller 22. When the trigger 10 is pressed in, the controller 22 executes control for starting the tying operation of tying the wire W around the rebars R.

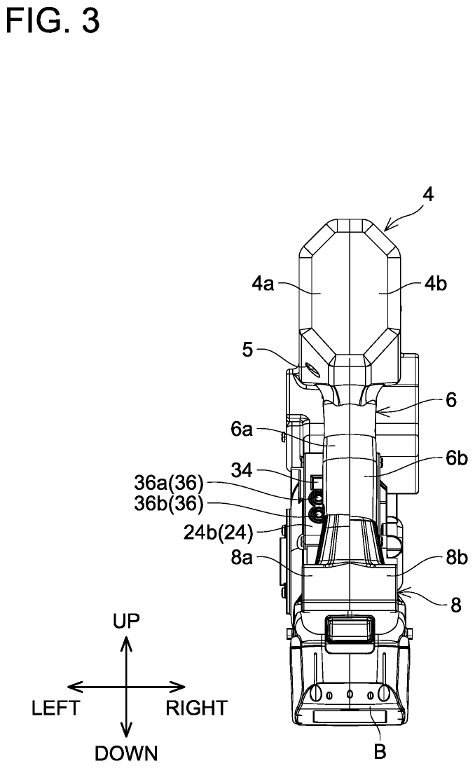

As shown in FIG. 1, the accommodating part 16 is disposed below the main body 4. The accommodating part 16 is disposed frontward than the grip 6. The accommodating part 16 comprises an accommodating part main body 18 and a cover member 20. The accommodating part main body 18 is attached to a front lower portion of the main body 4 by a screw 19 and is attached to a front portion of the battery receptacle 8 by the screw 9a. A rear surface 24 is disposed at a rear portion of the accommodating part main body 18. The rear surface 24 faces a front surface of the grip 6. The rear surface 24 comprises a first rear surface 24a and a second rear surface 24b. As shown in FIG. 3, when the rebar tying tool 2 is viewed from behind, the first rear surface 24a overlaps with the grip 6 but the second rear surface 24b does not overlap with the grip 6. Further, when the rebar tying tool 2 is viewed from behind, the second rear surface 24b is disposed to the left of the grip 6.

As shown in FIG. 1, the cover member 20 is configured to open and close an opening of the accommodating part main body 18. As shown in FIG. 2, an accommodating space 28 is defined by the accommodating part main body 18 and the cover member 20. A reel 30 on which the wire W is wound is disposed in the accommodating space 28. As such, the accommodating part 16 accommodates the reel 30.

As shown in FIG. 3, an indicator 34 and an adjusting unit 36 are disposed on the second rear surface 24b of the accommodating part main body 18. As shown in FIG. 2, the indicator 34 and the adjusting unit 36 are disposed upward than the controller 22. Each of the indicator 34 and the adjusting unit 36 is electrically connected to the controller 22 by a wiring (not shown) extending between the accommodating part main body 18 and the battery receptacle 8.

The indicator 34 is configured to display a status of the rebar tying tool 2, such as a tying condition for tying the wire W around the rebars R and remaining charge in the battery B. The adjusting unit 36 is a member for setting the tying condition, such as a winding number of the wire

W on the rebars R. and a twisting intensity of the wire W. In the present embodiment, the adjusting unit 36 comprises two microswitches 36a, 36b. When the microswitch 36a is pressed, the controller 22 increases the winding number of the wire W (or increases the twisting intensity of the wire W), and When the microswitch 36b is pressed, the controller 2.2 decreases the winding number of the wire W (or decreases the twisting intensity of the wire W). The adjusting unit 36 is not limited to the microswitches 36a, 36b, and may comprise a dial switch.

As shown in FIG. 2, the rebar tying tool 2 comprises a feeding unit 40, a cutter unit 42, and a twisting unit 44. The feeding unit 40 is accommodated in the main body 4. The feeding unit 40 is disposed at the front lower portion of the main body 4. The feeding unit 40 comprises a feeding motor 48, a feeding part 50, and a guiding part 52. The feeding motor 48 is connected to the controller 22 via a cable that is not shown. The feeding motor 48 is configured to be driven by electric power supplied from the battery B. The feeding motor 48 is configured to switch between a forward driven state and a reverse driven state by the controller 22.

When the feeding motor 48 is driven forward, the feeding part 50 feeds the wire W wound on the reel 30 to the guiding part 52 by forward rotation of its roller 54. The guiding part 52 guides the wire W fed from the feeding part 50 in a loop shape around the rebars R. Further, when the feeding motor 48 is driven in reverse, the feeding part 50 pulls back the wire W toward the reel 30 from the guiding part 52 by reverse rotation of its roller 54.

The cutter unit 42 comprises a cutter that is not shown. The cutter is configured to cut the wire W by pivoting following motion of the twisting unit 44.

The twisting unit 44 is accommodated in the main body 4. The twisting unit 44 extends frontward from an internal rear portion of the main body 4. Further, the indicator 34 and the adjusting unit 36 are disposed downward than the twisting unit 44. The twisting unit 44 comprises a twisting motor 58 and a retaining part 60. The twisting motor 58 is configured to be driven by electric power supplied from the battery B. The twisting motor 58 is controlled by the controller 22, Rotation of the twisting motor 58 is transmitted to the retaining part 60,

The retaining part 60 is configured to move out, move in, and rotate following the rotation of the twisting motor 58, The retaining part 60 comprises a retaining member 62. The retaining member 62 is arranged at a front portion of the retaining part 60. The retaining member 62 comprises two members 62a, 62h that overlap each other in the up-down direction, The retaining member 62 is configured to switch between a fully closed state, a half-opened state, and a fully opened state following the rotation of the twisting motor 58 by its two members 62a, 62b moving in directions approaching each other in the left-right direction. Although detailed description on the configuration of the retaining member 62 will be omitted, when the retaining member 62 switches from the fully opened state to the half-opened state, it retains one point on the wire W around the rebars R. When the retaining member 62 switches from the half-opened state to the fully closed state, it further retains another point on the wire W around the rebars R.

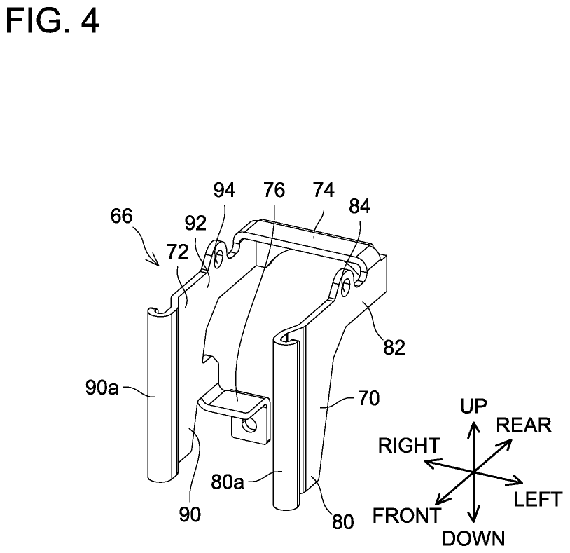

As shown in FIG. 2, the rebar tying tool 2 further comprises a contacting member 66 and an elastic member 68 (see FIG, 5). The contacting member 66 is disposed at a front portion of the main body 4. The contacting member 66 is disposed in front of the twisting unit 44. The contacting member 66 is composed of an iron-based metal material. As shown in FIG. 4, the contacting member 66 comprises a first contacting part 70, a second contacting part 72, a coupler 74, and a bent part 76. The first contacting part 70, the second contacting part 72, the coupler 74, and the bent part 76 are integrated.

The first contacting part 70 is disposed apart from the second contacting part, 72 toward the left. The first contacting part 70 comprises a front portion 80 and a rear portion 82. The front portion 80 extends in the up-down direction. A front end 80a of the front portion 80 curves in a direction separating away from the second contacting part 72 (that is, leftward). The rear portion 82 extends rearward from a rear upper portion of the front portion 80. A first opening 84 is defined at an intermediate position of the rear portion 82 in the front-rear direction. The first opening 84 penetrates the rear portion 82 in the left-right direction.

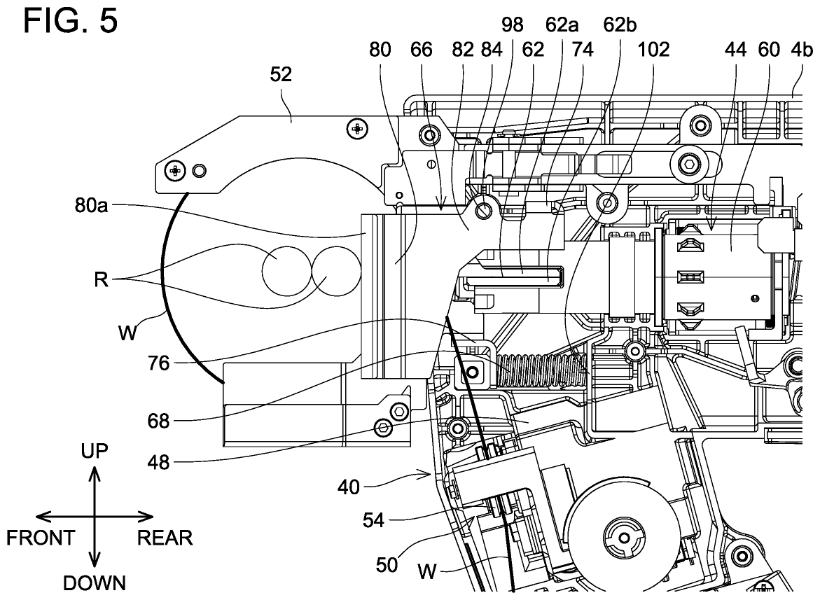

A shape of the second contacting part 72 is in a symmetric relationship with a shape of the first contacting part 70 with respect to a plane perpendicularly intersecting the left-right direction. That is, a shape of each of a front portion 90 and a rear portion 92 of the second contacting part 72 is in a symmetric relationship with a shape of corresponding one of the front portion 80 and the rear portion 82 of the first contacting part 70 with respect to the plane perpendicularly intersecting the left-right direction. A front end 90a of the front portion 90 of the second contacting part 72 curves in a direction separating away from the first contacting part 70 (that is, rightward). Further, a second opening 94 penetrates the rear portion 92 of the second contacting part 72 in the left-right direction. A support shaft 98 shown in FIG. 5 is inserted into the first opening 84 and the second opening 94. The support shaft 98 extends in the left-right direction (which is a direction perpendicular to a sheet surface in FIG. 5). The support shaft 98 is interposed between the left main body 4a and the right main body 4b. Due to this, the contacting member 66 is supported by the main body 4. The contacting member 66 can pivot about the support shaft 98.

As shown in FIG. 4, the coupler 74 couples a vicinity of a rear end of the rear portion 82 of the first contacting part 70 and a vicinity of a rear end of the rear portion 92 of the second contacting part 72. Due to this, the first contacting part 70 and the second contacting part 72. move integrally. The coupler 74 increases physical strength of the contacting member 66. The bent part 76 extends toward the first contacting part 70 from a rear lower portion of the second contacting part 72, then bends to extend downward.

As shown in FIG. 5, the elastic member 68 is interposed between a rear surface of the bent part 76 and a protruding piece 102 on the right main body 4b. In FIG. 5, a part of the constituent components of the rebar tying tool 2 is omitted to facilitate understanding of a position of the elastic member 68. The elastic member 68 extends in the front-rear direction. The elastic member 68 is disposed downward than the support shaft 98. The elastic member 68 may for example be a coil spring. The elastic member 68 is configured to bias the second contacting part 72 frontward. Due to this, the contacting member 66 is biased frontward. Further, the elastic member 68 is configured to contract (elastically deform) when the contacting member 66 pivots rearward about the support shaft 98.

Next, the tying operation of the wire W onto the rebars R will be described. Prior to performing the tying operation, the retaining member 62 of the twisting unit 44 is maintained in the fully opened state. When the trigger 10 is pressed in by the operator in a state of having the rebar tying tool 2 set on the rebars R such that the rebars R are in contact with the first contacting part 70 and the second contacting part 72, the tying operation is started by control of the controller 22. As shown in FIG. 5, in the tying operation, firstly the feeding motor 48 is driven forward and the wire W that was wound on the reel 30 is fed out from the feeding part 50 to the guiding part 52. The wire W is guided by the guiding part 52 around the rebars R in the loop shape.

From this state, when the driving of the feeding motor 48 is stopped and the twisting motor 58 is driven, the retaining member 62 switches from the fully opened state to the half-opened. state. Due to this, a tip end of the wire W is retained by the retaining member 62.

From this state, when the twisting motor 58 stops to drive and the feeding motor 48 is driven in reverse, the feeding part. 50 pulls the wire W back from the rebars R. Since the tip end of the wire W is retained by the retaining member 62, the loop of the wire W around the rebars R is tightened as the wire W is pulled back, and the wire W comes tightly in contact with the rebars R. Even if the wire W is further pulled back from this state, since a biasing force applied by the elastic member 68 on the contacting member 66 is greater than a pushing force by which the rebars R push the contacting member 66 due to tension on the wire W, the contacting member 66 thus does not pivot. When it is determined by the controller 22 that torque applied to the feeding motor 48 (such as a current value of the feeding motor 48) exceeded a certain value, the feeding motor 48 is stopped.

From this state, when the twisting motor 58 is driven, the retaining member 62 switches from the half-opened state to the fully closed state. Due to this, a rear end of the wire W is retained by the retaining member 62. When the twisting motor 58 is further driven, the wire W is cut by pivoting of the cutter of the cutter unit 42. Due to this, two points, being the tip end and the rear end of the wire W, are retained by the retaining member 62 in the state where the wire W is in tight contact with the rebars R.

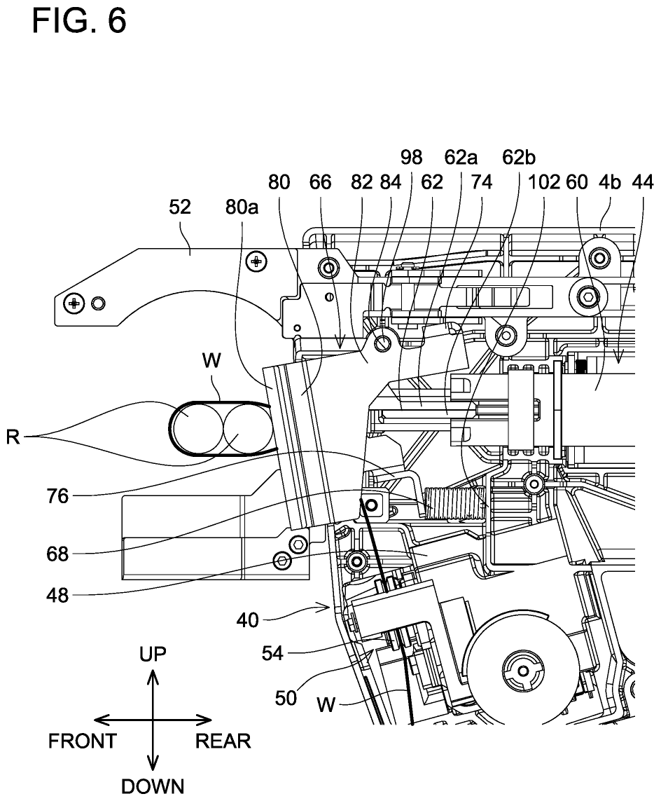

From this state, when the twisting motor 58 is driven, the retaining part 60 moves rearward (that is, toward the twisting motor 58). The tip end and. the rear end of the wire W retained by the retaining member 62 move rearward. Due to this, they are pulled rearward in the state where the wire W is in tight contact with the rebars R. As the tip end and the rear end of the wire W move, the tension on the wire W increases, and the pushing force by which the rebars R. push the contacting member 66 increases. When the pushing three becomes greater than the biasing force applied by the elastic member 68 on the contacting member 66, the rebar tying tool 2 is drawn toward the rebars R as shown in FIG. 6, and the contacting member 66 pivots rearward about the support shaft 98. As a result, an interval between the rebars R and the retaining member 62 in the front-rear direction narrows, and a twisting allowance of the wire W is thereby secured.

When the retaining part 60 moves rearward over a predetermined distance, rearward movement of the retaining part 60 is stopped and the retaining part 60 rotates, by which the wire W is twisted. As the wire W is twisted, a length of the wire W in the front-rear direction becomes shorter. Due to this, the tension on the wire W is further increased, and the pushing force by which the rebars R push the contacting member 66 also increases even more. As a result, the rebar tying tool 2 is drawn toward the rebars R, and the contacting member 66 further pivots rearward about the support shaft 98. While the retaining part 60 is twisting the wire W, when it is determined by the controller 22 that torque applied to the twisting motor 58 (such as a current value of the twisting motor 58) exceeded a certain value, the twisting motor 58 is stopped from driving. After this, series of operations for returning arrangement of respective constituent components of the rebar tying tool 2 to their state prior to the tying operation are performed by control of the controller 22.

During the aforementioned series of operations, the elastic member 68 biases the contacting member 66 frontward. Due to this, the state of contact between the contacting member 66 and the rebars R is maintained during the tying operation.

The rebar tying tool 2 of the present embodiment is configured to tie rebars R with the wire W The rebar tying tool 2 comprises: the feeding unit 40; the twisting unit 44; the grip 6; the indicator 34; and the rear surface 24. The feeding unit 40 is configured to feed the wire W around the rebars R. The twisting unit 44 is configured to twist the wire W around the rebars R. The grip 6 is disposed downward than the twisting unit 44 and configured to be gripped by an operator. The indicator 34 is configured to indicate a status of the rebar tying tool 2. The rear surface 24 is disposed frontward than the grip 6 and facing a front surface of the grip 6. The indicator 34 is disposed on the rear surface 24. In the above configuration, when the operator grips the grip 6, the rear surface 24 is less likely to be hidden by a hand of the operator gripping the grip 6, and thus the indicator 34 is also less likely to be hidden by the hand of the operator. Further, when the rebar tying tool 2 is tilted, the indicator 34 enters a field of view of the operator. Due to the foregoing, the operator can easily recognize the indicator 34 visually.

The rebar tying tool 2 further comprises the adjusting unit 36 configured to adjust the tying condition of the rebar tying tool 2. The adjusting unit 36 is disposed on the rear surface 24. In the above configuration, the operator can operate the adjusting unit 36 while seeing the indicator 34 in a state of gripping the grip 6.

The rear surface 24 comprises the first rear surface 24a overlapping with. the grip 6 and the second rear surface 24b not overlapping with the grip 6 when the rebar tying tool 2 is viewed from behind. At least a part of the indicator 34 is disposed on the second rear surface 24b. In the above configuration, the indicator 34 might enter the field of view of the operator even when the rebar tying tool 2 is not tilted. Due to this, it becomes easier for the operator to visually recognize the indicator 34.

The rear surface 24 is disposed on the rear portion of the accommodating part 16 configured to accommodate the reel 30 around which the wire W is wound. In the above configuration, since the accommodating part 16 is disposed in a. space in front of the grip 6, a size of a part of the rebar tying tool 2 that is upward than the grip 6 (that is, main body 4) can be reduced, and the rear portion of the accommodating part 16 can be utilized as the rear surface 24 on which the indicator 34 is disposed.

The rebar tying tool 2 further comprises: the controller 22 electrically connected to the indicator 34. The indicator 34 is disposed below the twisting unit 44 and disposed above the controller 22. In the above configuration, the indicator 34 and the controller 22 are connected by a cable. Since the indicator 34 is disposed downward than the twisting unit 44 and upward than the controller 22, the indicator 34 and the controller 22 can be connected without extending the cable through the twisting unit 44. Due to this, an arrangement of the cable connecting the indicator 34 and the controller 22 can be suppressed from becoming complicated.

Further, the rebar tying tool 2 is configured to tie the rebars R with the wire W. It comprises the feeding unit 40, the twisting unit 44, the main body 4, and the contacting member 66. The feeding unit 40 is configured to feed the wire W around the rebars R. The twisting unit 44 is configured to twist the wire W around. the rebars R. The main body 4 is configured to accommodate the feeding unit 40 and the twisting unit 44. The contacting member 66 is disposed in front of the twisting unit 44 and is configured to come into contact with the rebars R upon the tying operation. In the state where the twisting unit 44 is retaining the wire W, a contacting position at which the contacting member 66 comes into contact with the rebars R and a retaining position at which the twisting unit 44 retains the wire are configured to move relative to each other in directions separating away from one another. In the state where the twisting unit 44 is retaining the wire W, the retaining position is configured to move rearward with respect to the main body 4. In this configuration, by moving the retaining position rearward with respect to the main body 4, the contacting position and the retaining position can be moved relative to each other in directions separating away from one another.

In the state where the twisting unit 44 is retaining the wire W, the contacting position is configured to move rearward with respect to the main body 4. In the above configuration, when the wire W is twisted by the twisting unit 44 in a state where the wire W is in tight contact with the rebars R, the contacting position moves rearward with respect to the main body 4. Due to this, the rebars R move rearward relatively with respect to the rebar tying tool 2. As a result, the tension on the wire W is reduced as compared to a case where an interval between the rebars R and the twisting unit 44 is maintained constant. As a result of this, the rebar tying tool 2 can be suppressed from being damaged due to an excessive load being applied to the contacting member 66 and the twisting unit 44.

The contacting member 66 is configured to move rearward together with the rebars R with respect to the main body 4 when it comes into contact with the rebars R. in the above configuration, the contacting member 66 moves rearward together with the rebars R upon the tying operation. Due to this, a load applied to the contacting member 66 can be reduced as compared to a case in which the contacting member 66 does not move rearward together with the rebars R, that is, a case where the contacting position moves rearward due to the contacting member 66 composed for example of an elastic material deforming elastically. As a result, the rebar tying tool 2 can be suppressed from being damaged.

The rebar tying tool 2 further comprises the elastic member 68 configured to deform elastically as the contacting member 66 moves rearward together with the rebars R. in this configuration, a load applied to the main body 4 from the rebars R through the contacting member 66 can be suppressed by elastic deformation of the elastic member 68.

The contacting member 66 comprises: the first contacting part 70; and the second contacting part 72 disposed apart from the first contacting part 70. The first contacting part 70 and the second contacting part 72 come into contact with the rebars R. upon the tying operation.

In this configuration, the rebars R come into contact with the contacting member 66 at two points in the left-right direction upon the tying operation. Due to this, the rebars R can stably be brought into contact with the contacting member 66 as compared to a case in which the rebus R come into contact with the contacting member 66 at one point.

The front end 80a of the first contacting part 70 and the front end 90a of the second contacting part 72 are curved in directions separating away from one another. In this configuration, the rebars R come into contact with these curved portions of the contacting member 66. Due to this, durability of the contacting member 66 can be improved.

The first contacting part 70 and the second contacting part 72 each extend in the up-down. direction. In the above configuration, the rebars R can be suppressed from separating away from the contacting member 66 even when a position of the rebars R is displaced in up-down direction.

The contacting member 66 further comprises the coupler 74 coupling the first contacting part 70 and the second contacting part 72. In this configuration, strength of the contacting member 66 can be improved. Further, since the first contacting part 70 and the second contacting part 7 2. move integrally, an orientation of the rebar tying tool 2 can be suppressed from being changed upon the tying operation.

(Corresponding Relationship)

The rear surface 24 is an example of “facing surface”, the feeding unit 40 is an example of “pullback unit”, the front end 80a is an example of “one end of the first contacting part on a rebars side”, and the :front end 90a is an example of “one end of the second contacting part on the rebars side”.

### Variant of First Embodiment

A variant of the first embodiment will be described. In the variant of the first embodiment, points that differ from the first embodiment will be described, and explanations on points that are same as the first embodiment will be omitted. In the variant of the first embodiment, the elastic member 68 has a smaller elastic coefficient as compared to the elastic member 68 of the first embodiment, in other words is more contractable (elastically deformable). In the variant of the first embodiment, when the wire W is pulled back from the rebars ft by the feeding part 50 in the tying operation of the wire W onto the rebars R, the contacting member 66 thereby pivots. Specifically, when the wire W is pulled back from the rebars R by the feeding part 50, the loop of the wire W around the rebars R is tightened, and the wire W tightly contacts around the rebars R. From this state, as the wire W is further pulled back, the tension on the wire W increases, and the pushing three by which the rebars R push the contacting member 66 increases. When the pushing force becomes greater than the biasing three applied by the elastic member 68 on the contacting member 66, the rebar tying tool 2 is drawn toward the rebars R., and the contacting member 66 pivots rearward about the support shaft 98.

In the present embodiment, the rebar tying tool 2 further comprises the feeding unit 40. The feeding unit 40 is configured to pull back the wire W that is wrapped around the rebars R. When the contacting member 66 comes into contact with the rebars R upon pulling back the wire W, the contacting position can thereby move rearward with respect to the main body 4. In this configuration, when the wire W that is wrapped around the rebars R is pilled back by the feeding unit 40, the wire W comes into tight contact with the rebars R. When the wire W around the rebars R is further pulled back in this state, the contacting position moves rearward. Due to this, the rebars R move rearward relatively with respect to the rebar tying tool 2. As a result, the tension on the wire W is reduced as compared to a case where an interval between the rebars R and the twisting unit 44 is maintained constant. Due to this, the rebar tying tool 2 can be suppressed from being damaged due to an excessive load being applied to the contacting member 66 and the twisting unit 44.

### Second Embodiment

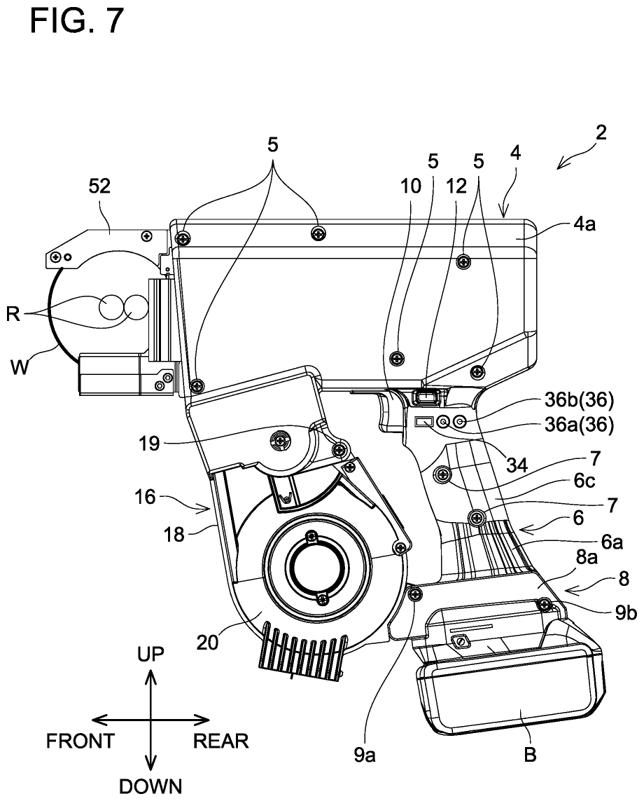

A second embodiment will be described with reference to FIG. 7. In the second embodiment, points that differ from the first embodiment will be described, and explanations on points that are same as the first embodiment will be omitted by giving same reference signs. In the second embodiment, positions of the indicator 34 and. the adjusting unit 36 are different from those of the first embodiment.. The indicator 34 and the adjusting unit 36 are disposed on a left side surface 6c of the grip 6. The indicator 34 is disposed below the trigger lock 12 at a position close thereto. The indicator 34 is disposed on the rear side from the trigger 10 at a position close thereto. The adjusting unit 36 is disposed close to the trigger lock 12. The adjusting unit 36 is disposed on the rear side from the indicator 34 at a. position close thereto, and is disposed also close to the trigger 10. The trigger 10 is to be operated by an index finger of a hand of the operator which grips the grip 6, and the trigger lock 12 and the adjusting unit 36 are operated by a thumb of the hand of the operator which grips the grip 6.

The rebar tying tool 2 of the present embodiment is configured to tie the rebars R. with the wire W. The rebar tying tool 2 comprises: the feeding unit 40; the twisting unit 44; the grip 6; and the indicator 34. The feeding unit 40 is configured to feed the wire W around the rebars R. The twisting unit 44 is configured to twist the wire W around the rebars R. The grip 6 is disposed downward than the twisting unit 44 and configured to be gripped by an operator. The indicator 34 is configured. to indicate a status of the rebar tying tool 2. The indicator 34 is disposed on the left side surface 6c of the grip 6. In this configuration, since the indicator 34 is disposed on the left side surface 6c of the grip 6, the indicator 34 enters the field of view of the operator when the rebar tying tool 2 is tilted, for example when the rebar tying tool 2 is tilted as if the rebar tying tool 2 is rotated around an axis extending along the up-down. direction. Due to this, the operator can easily recognize the indicator 34 visually.

The rebar tying tool 2 further comprises: the trigger 10 and the adjusting unit. 36. The trigger 10 is configured to drive the feeding unit 40 and the twisting unit 44 based on an operation by the operator. The adjusting unit 36 is configured to adjust a tying condition of the rebar tying tool 2. The adjusting unit 36 is disposed near the trigger 10. In this configuration, the operator can operate both the trigger 10 and the adjusting unit 36 with the hand gripping the grip 6.

The adjusting unit 36 is disposed near the indicator 34. In the above configuration, the operator can operate the adjusting unit 36 while checking the indicator 34.

The rebar tying tool 2 further comprises: the trigger lock 12 configured to prohibit an operation of the trigger 10. The trigger lock 12 is disposed near the adjusting unit 36, In this configuration, the operator can operate the trigger lock 12 with a finger that operates the adjusting unit 36.

### Third Embodiment

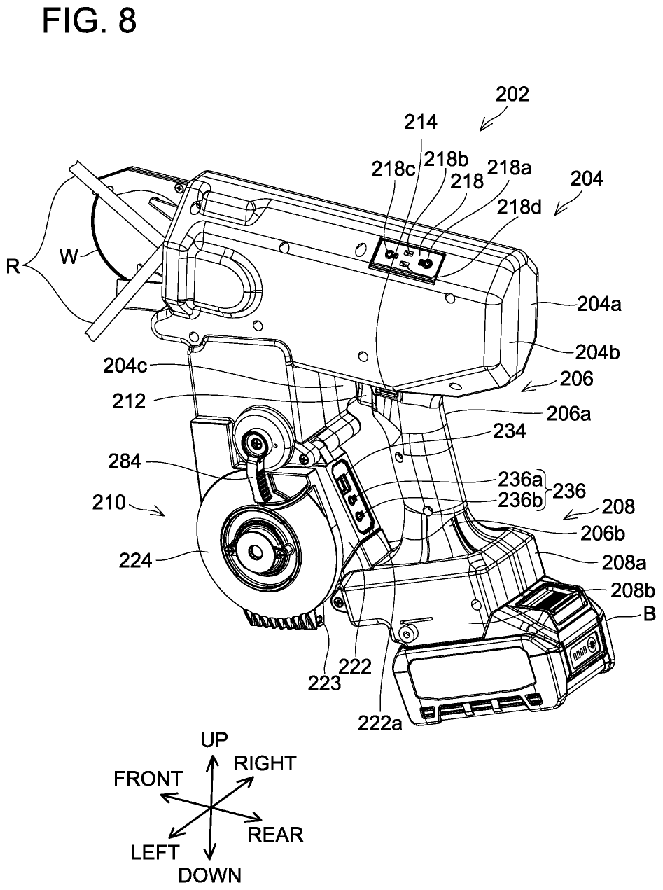

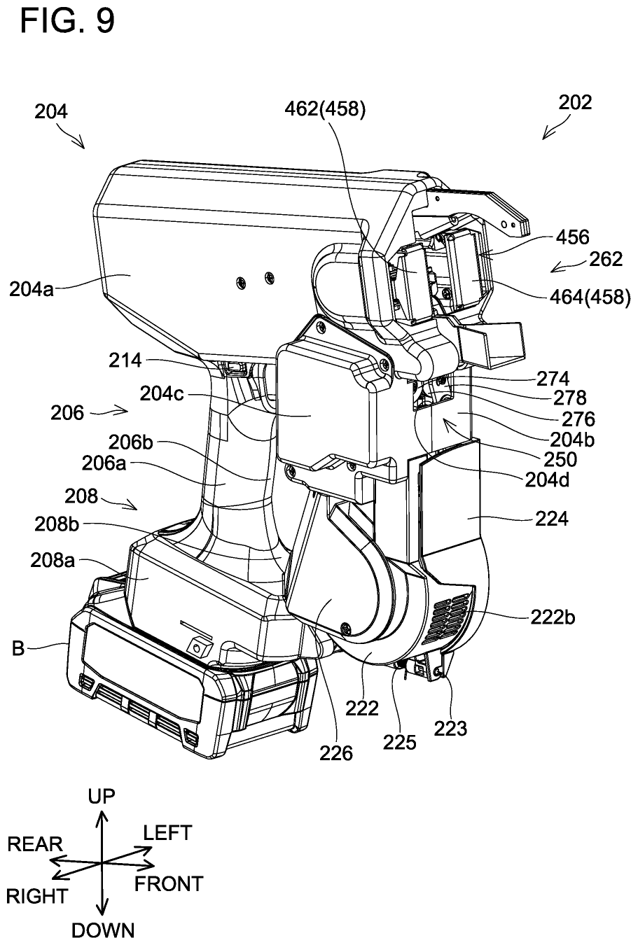

A rebar tying tool 202 of a third embodiment will be described with reference to FIGS. to 34. In the third embodiment, explanations on points that are same as the first embodiment are omitted. As shown in FIG. 8, the rebar tying tool 202 comprises a main body 204, a grip 206, a battery receptacle 208, a battery B, and an accommodating part 210. The main body 204 comprises a right main body 204a that composes an outer shape of a right half, a left main body 204b that composes an outer shape of a left half, and a motor cover 204c (see FIG. 9). The motor cover 204c is attached to the right main body 204a.

The grip 206 is configured to be gripped by the operator. The grip 206 is connected to a rear lower portion of the main body 204. The grip 206 is integrated with the main body 204, The grip 206 comprises a right grip 206a that composes an outer shape of its right half and a left grip 206b that composes an outer shape of its left half.

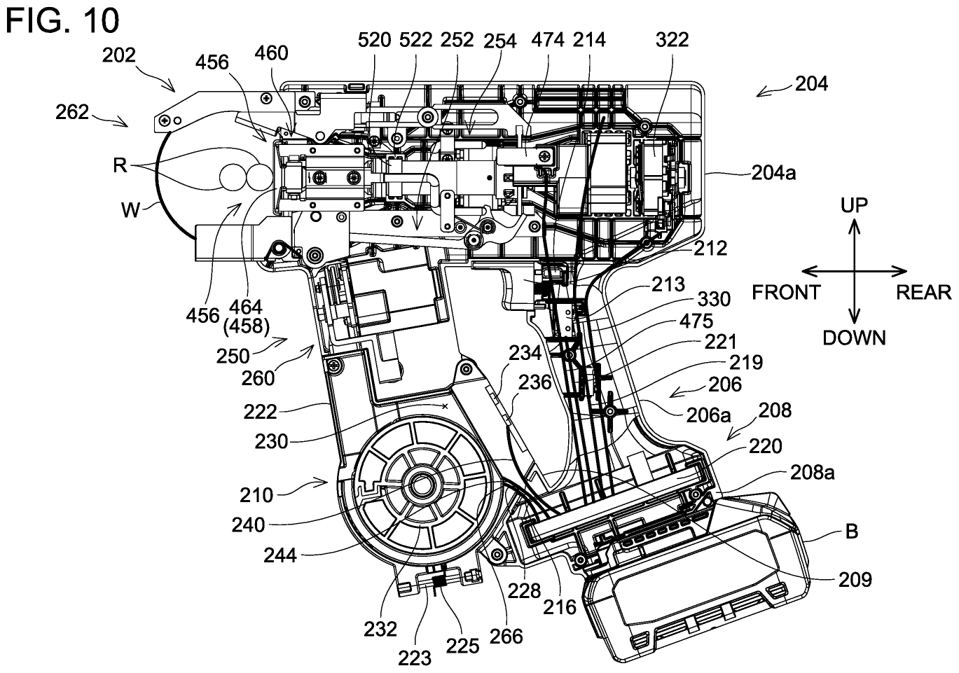

A trigger 212 is attached at an upper portion of a front surface of the grip 206. The trigger 212 is configured to be operated by the operator. As shown in FIG. 10, a trigger switch 213 configured to detect whether or not the trigger 212 has been pressed in is accommodated inside the grip 206.

As shown in FIG. 8, a trigger lock 214 is attached to an upper portion of the left surface of the grip 206. The trigger lock 214 is disposed near a connecting. position between the main body 204 and the grip 206. The trigger lock 214 is configured to move between an allowing position and a prohibiting position. When the trigger lock 214 is in the allowing position, a press-in operation on the trigger 212 is allowed. When the trigger lock 214 is in the prohibiting position, the press-in operation on the trigger 212 is prohibited.

The battery receptacle 208 is connected to a lower portion of the grip 206. The battery receptacle 208 is integrated with the grip 206. The battery B is detachably attached to the battery receptacle 208. The battery receptacle 208 comprises a right battery receptacle 208a that composes an outer shape of its right half and a left battery receptacle 208h that composes an outer shape of its left half. A coupler 209 is arranged on a front upper portion of the battery receptacle 208. The coupler 209 is integrated with the battery receptacle 208. As shown in FIG. 10, an opening 216 is defined on a front upper surface of the coupler 209.

The rebar tying tool 202 further comprises a controller 220. The controller 220 is accommodated in the battery receptacle 208. The controller 220 and the trigger switch 213 are electrically connected by a fifth connecting cable 221. The fifth connecting cable 221 extends from the trigger switch 213 through inside the grip 206, and further extends inside the battery receptacle 208 to the controller 220. When the trigger 212 is pressed in, the controller 220 detects a signal from the trigger switch 213 and executes control for starting a. tying operation for tying a wire W around rebars R.

As shown in FIG. 8, an indicator 218 is disposed at a rear upper portion of the main body 204. The indicator 218 comprises a main power switch 218a, a main power LED 218b, a mode-shifting switch 218c, and a mode-displaying LED 218d. The main power switch 218a is configured to accept an operation by the operator for switching main power of the rebar tying tool 202 between an on state and an off state. The main power LED 218h is configured to display the on state and the off state of the main power of the rebar tying tool 202. The mode-shilling switch 218c is configured. to accept an operation by the operator for switching an operation mode of the rebar tying tool 202. The mode-displaying LED 218d is configured to display the operation mode of the rebar tying tool 202. For example, the operation mode of the rebar tying tool 202 may comprise a single action mode capable of performing one tying operation each time the trigger 212 is operated and a multiple action mode capable of performing multiple tying operations while the trigger 212 is operated.

The indicator 218 and the controller 220 are electrically connected by a sixth connecting cable 219 (see FIG. 10). As Shown in FIG. 10, the sixth connecting cable 219 extends from the indicator 218 and on. the left side of a twisting unit 254 to be described later, further extends inside the grip 206 via the connecting position between the main body 204 and the grip 206, and through inside the battery receptacle 208 to the controller 220.

As shown in FIGS. 8 and 9, the accommodating part 210 comprises an accommodating part main body 222, a cover member 224, and an auxiliary cover member 226. The accommodating part main body 222 is coupled to a front lower portion of the main body 204 and a front portion of the coupler 209. As shown in FIG. 10, an opening 228 is defined at a rear lower portion of the accommodating part main body 222. The opening 228 faces the opening 216. As shown in FIG. 8, a rear surface 222a is arranged at a rear portion of the accommodating part main body 222. The rear surface 222a faces the front surface of the grip 206.

An indicator 234 and an adjusting unit 236 are disposed on the rear surface 222a of the accommodating part main body 222. The indicator 234 is configured to display a status of the rebar tying tool 202, such as a tying condition for tying the wire W around the rebars R. and remaining charge in the battery B. The adjusting unit 236 is configured to accept an operation by the operator for adjusting a tying force of the wire W. In the present embodiment, the adjusting unit 236 comprises two microswitches 236a, 236b. When the microswitch 236a is operated, a set value of the tying force of the wire W increases by one level, and when the microswitch 236b is operated, the set value of the tying three of the wire W decreases by one level. The adjusting unit 236 is not. limited to the microswitches 236a, 236b, and may comprise a dial switch.

As shown in FIG. 10, the indicator 234 and the adjusting unit 236 are electrically connected to the controller 220 by first connecting cables 240. The first connecting cables 240 extend from the indicator 234 and the adjusting unit 236 through inside the accommodating part main body 222, further extends through inside the coupler 209 via the openings 228, 216, and through inside the battery receptacle 208 to the controller 220. Since the first connecting cables 240 do not extend inside the main body 204, they do not extend near the twisting unit 254 to be described later.

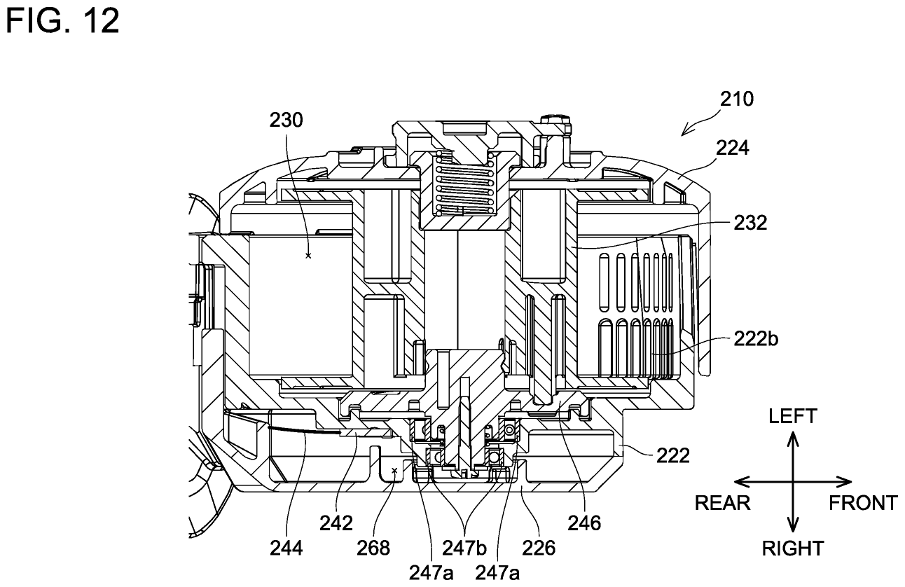

As shown in FIG. 8, the cover member 224 is attached to the accommodating part main body 222 so as to be pivotable about a pivoting portion 223 at a lower portion of the accommodating part main body 222, The cover member 224 is configured to open and close an accommodation. opening defined on a left side surface of the accommodating part main body 222. The cover member 224 is biased in an opening direction by a biasing part 225 (see FIG. 9). The biasing part 225 may for example be a torsion spring. An accommodating space 230 (see FIG. 10) is defined by the accommodating part main body 222 and the cover member 224. A reel 232 (see FIG. 10 on which the wire W is wound is accommodated in the accommodating space 230. In a state where the cover member 224 is open, the reel 232 can be set in or removed from the accommodating part main body 222. On the other hand, in a state where the cover member 224 is closed, the reel 232 is prohibited from being set in or removed from the accommodating part. main body 222. Hereinbelow, the state where the cover member 224 is open may also be termed an allowed state, and the state where the cover member 224 is closed may also be termed a prohibited state. Further, as shown in FIG. 9, a hole 222b is defined in a front surface of the accommodating part main body 222. The operator can check a remaining amount of the wire W wound on the reel 232 by seeing the reel 232 through the hole 222b. The auxiliary cover member 226 is configured to cover a right side surface of the accommodating part main body 222. Due to this, a passage space 268 (see FIG. 12) is defined between the right side surface of the accommodating part main body 222 and the auxiliary cover member 226.

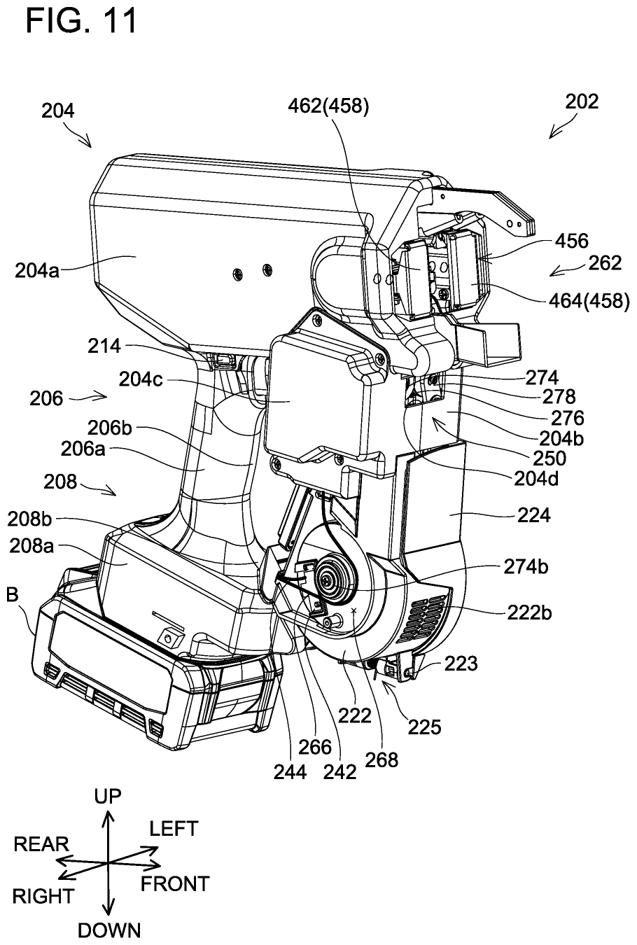

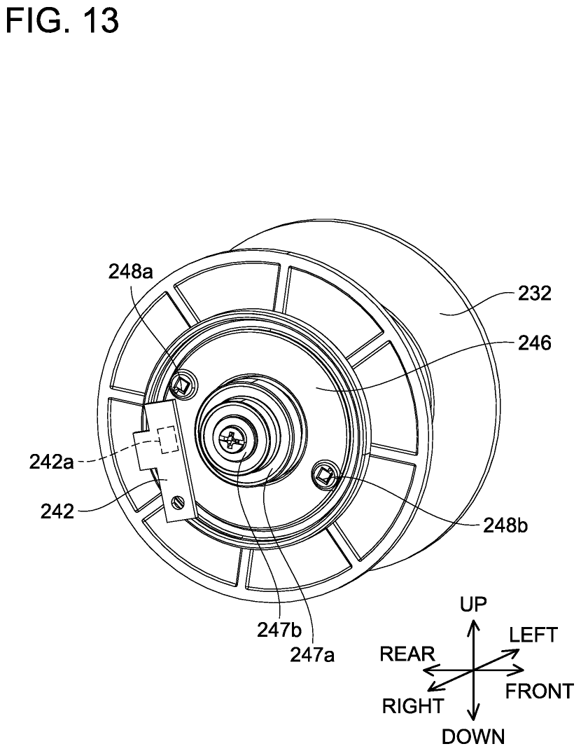

As shown in FIG. 12, the accommodating part 210 further comprises a rotating base 246. The rotating base 246 is rotatably supported by the accommodating part main body 222 via a first bearing 247a and a second bearing 247b. The rotating base 246 is disposed in the accommodating space 230. When the reel 232 is set in the accommodating space 230, the rotating base 246 and the reel 232 engage with each other. When the reel 232 rotates, the rotating base 246 rotates together with the reel 232. As shown in FIG. 13, permanent magnets 248a, 248b are attached to a right surface of the rotating base 246. The permanent magnets 248a, 248b are arranged with 180 degrees intervals in a circumferential direction of the rotating base 246. As shown in FIG. 11, a sensor substrate 242 is attached to the right side surface of the accommodating part main. body 222. In a state where the auxiliary cover member 226 covers the right side surface of the accommodating part main body 222, the sensor substrate 242 is disposed in the passage space 268. As shown in FIG. 13, a Magnetic sensor 242a is attached to the sensor substrate 242.

When the reel 232 rotates in the state where the reel 232 is set in the accommodating space 230, the permanent magnets 248a, 248b rotate accompanying rotation of the rotating base 246, and magnetics detected by the magnetic sensor 242a thereby change. The rotation of the reel 232 is detected by this change in the magnetics detected by the magnetic sensor 242a.

As shown in FIGS. 10 and 12, the magnetic sensor 242a and the controller 220 are electrically connected by a third connecting cable 244. The third connecting cable 244 extends from the magnetic sensor 242a through the passage space 268 along the right side surface of the accommodating part main body 222, further extends through inside the accommodating part main body 222, through inside the coupler 209 via the openings 228, 216, and further through inside the battery receptacle 208 to the controller 220. Since the third connecting cable 244 does not extend through inside the main body 204, it does not extend near the twisting unit 254 to be described later.

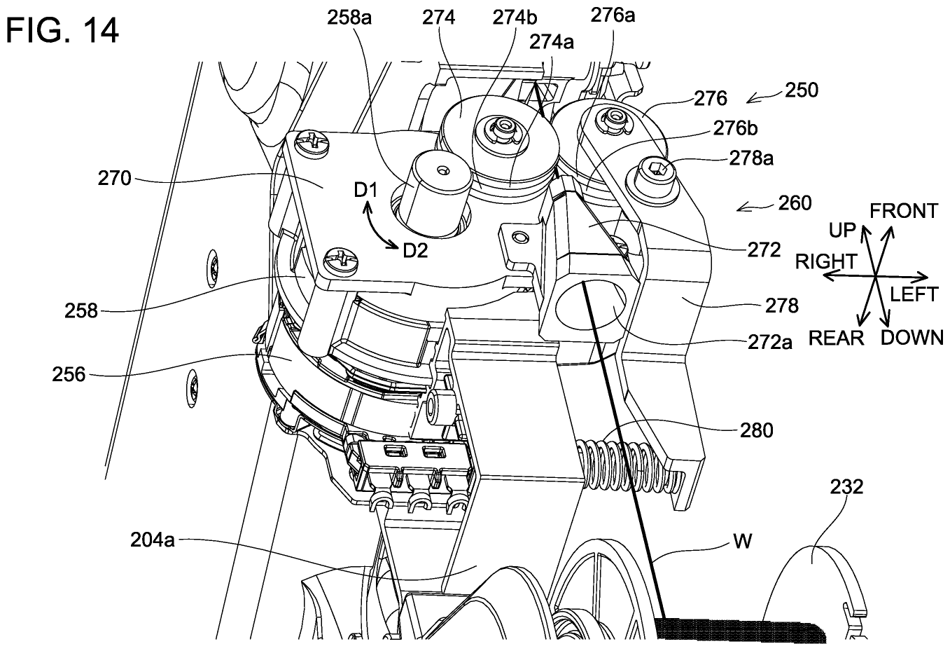

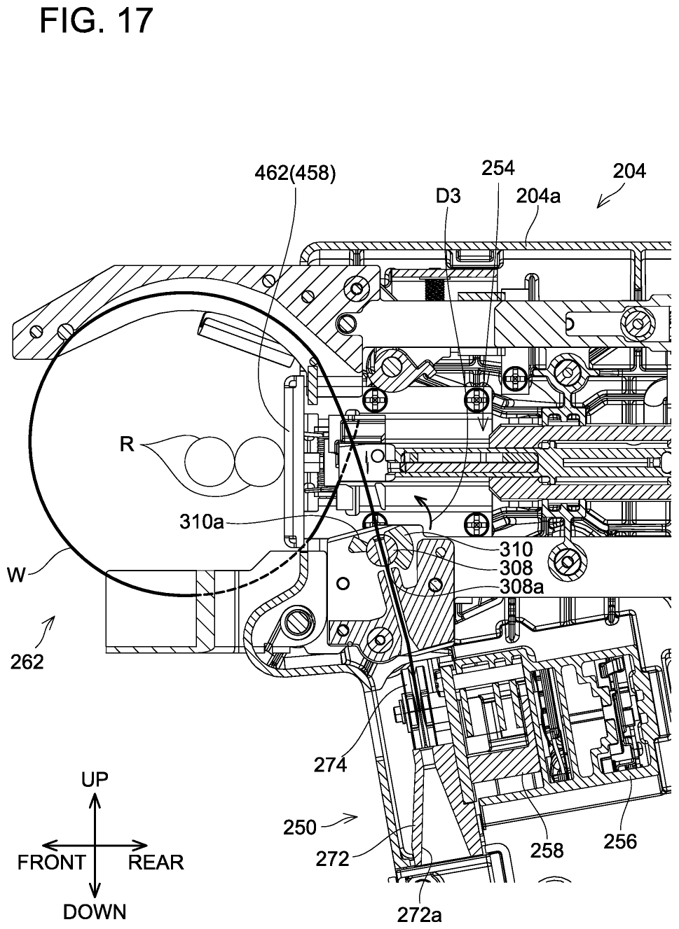

The rebar tying tool 202 comprises a feeding unit 250, a cutter unit 252, and a twisting unit 254. The feeding unit 250 is disposed at the front lower portion of the main body 204. As shown in FIG. 14, the feeding unit 250 comprises a. feeding motor 256, a reduction gear unit 258, a feeding part 260, and a guiding part 262 (see FIG. 17).

The feeding motor 256, the reduction gear unit 258, and the feeding part 260 are accommodated in the main body 204. The feeding motor 256 may for example be a brushless motor. The feeding motor 256 is disposed on the right side of the right main body 204a, and is covered by the motor cover 204c (see FIG. 11). The feeding motor 256 and the controller 220 are electrically connected by a second connecting cable 266 shown in. FIGS. 10 and 11. The second connecting cable 266 extends from the feeding motor 256 through inside the motor cover 204c, and further extends in the passage space 268 along the right side surface of the accommodating part main body 222. Further, the second connecting cable 266 extends through inside the accommodating part main body 222 and through inside the coupler 209 via the openings 228, 216, and through inside the battery receptacle 208 to the controller 220. Since the second connecting cable 266 does not extend through inside the main body 204, it does not extend near the twisting unit 254.

As shown in FIG. 14, the reduction gear unit 258 is coupled to the feeding motor 256. The reduction gear unit 258 is configured to decelerate rotation of the feeding motor 256 and transmit the same to the feeding part 260.

The feeding part 260 comprises a base part 270, a guide part 272, a driving roller 274, a driven roller 276, a link part 278, and a biasing part 280. The base part 270 is fixed to the right main body 204a. The guide part 272 is fixed to the base part 270. The guide part 272 includes a guide hole 272a through which the wire W is inserted.

The driving roller 274 is rotatably supported by the base part 270. Teeth 274a and a groove .274b are arranged on an outer circumferential surface of the driving roller 274. The teeth 274a mesh with an output gear 258a of the reduction gear unit 258. The output gear 258a is configured to rotate by the rotation of the feeding motor 256. The groove 274b is defined on the outer circumferential surface of the driving roller 274 along a direction of rotation of the driving roller 274. The driven roller 276 is rotatably supported by the link part 278. Teeth 276a and a groove 276b are arranged on an outer circumferential surface of the driven roller 276. The teeth 276a of the driven roller 276 mesh with the teeth 274a of the driving roller 274. The groove 276b extends along a direction of rotation of the driven roller 276 on the outer circumferential surface of the driven roller 276.

The link part 278 is pivotably supported by the base part 270 via a pivot shaft 278a. One end of the biasing part 280 is in contact with a lower portion of the link part 278 and another end of the biasing part 280 is in contact with the right main body 204a. The biasing part 280 is configured to bias the link part 278 with respect to the right main body 204a in a direction along which the driven roller 276 approaches toward the driving roller 274. Due to this, the driven roller 276 is pressed against the driving roller 274. As a result, the wire W is held between the groove 274b of the driving roller 274 and the groove 2761 of the driven roller 276. As shown in FIGS. 9 and 11, a window 204d through which the operator can visually identify the driving roller 274 and the driven roller 276 is defined in front surfaces of the left main body 204b and the motor cover 204c.

As shown in FIG. 14, the wire W moves by the rotation of the feeding motor 256 in a state where the wire W is held between the groove 274b of the driving roller 274 and the groove 276b of the driven roller 276. in the present embodiment, when the feeding motor 256 rotates forward, the output gear 258a rotates in a direction D1 and the driving roller 274 and the driven roller 276 thereby rotate in a direction of feeding the wire W out upward from below, and thus the wire W is fed out from the reel 232 into the guiding part 262 (see FIG. 17). As shown in FIG. 17, the guiding part 262 guides the fed-out wire W around the rebars R in a loop shape. On the other hand, when the feeding motor 256 rotates i.n reverse, the output gear 258a rotates in a. direction D2 shown in FIG. 12 and the driving roller 274 and the driven roller 276 thereby rotate in a direction of pulling the wire W back downward from above, and thus the wire W is pulled back from the guiding part 262 toward the reel 232.

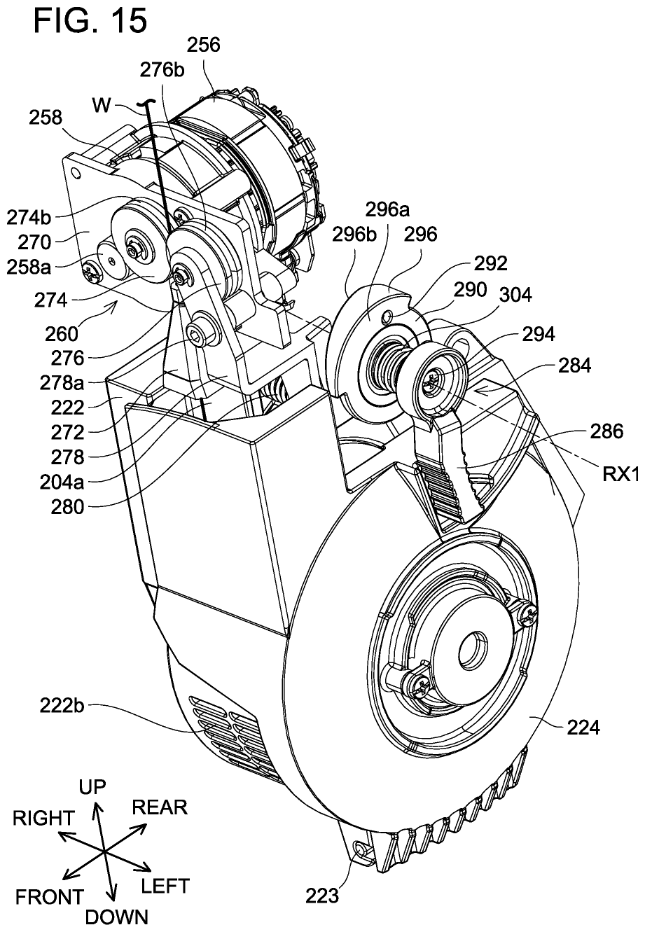

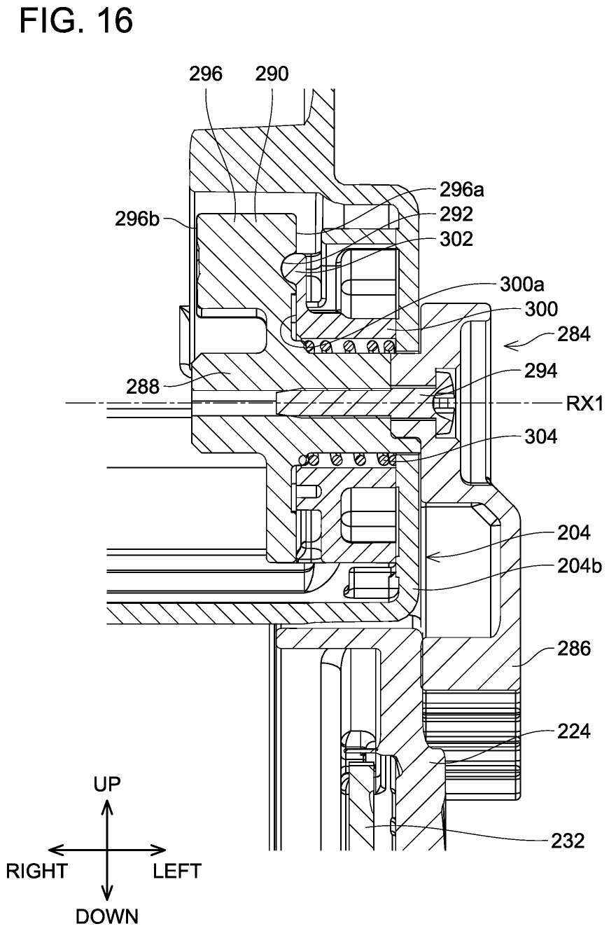

As shown in. FIG. 15, the rebar tying tool 202 further comprises an operating part 284. As shown in. FIG. 16, the operating part 284 comprises a lever 286, a coupler 288, a cam part 290, and a recess 292. The lever 286 is configured to he operated by the operator. The lever 286 is disposed. outside the main body 204. The lever 286 is disposed on the left side of the left main body 204b. The lever 286 is configured to pivot to and from an open position and a closed position about a pivot axis RX1 extending in the left-right direction. The lever 286 slides along outer surfaces of the left main body 204b and the cover member 224. When the lever 286 is in the dosed position, the lever 286 is in contact with the outer surface of the cover member 224. Due to this, the cover member 224 is maintained in the prohibited state. When the lever 286 moves from the dosed position toward the open position and the lever 286 no longer is in contact with the outer surface of the cover member 224, the cover member 224 shifts from the prohibited state to the allowed state by the biasing force of the biasing part 225 (see FIG. 9).

The coupler 288 couples the lever 286 and the cam part 290. The coupler 288 is integrated with the cam part. 290. The coupler 288 is fixed to the lever 286 by a screw 294. The coupler 288 penetrates the left surface of the left main body 204b.

The cam part 290 is disposed inside the main body 204. The cam part 290 is configured. to pivot integrally with the lever 286. The cam part 290 comprises an edge 296. A left surface 296a of the edge 296 is parallel to a plane that perpendicularly intersects the pivot axis RX1. Further, the left surface 296a of the edge 296 faces an inner surface of the left main body 204b. A recess 292 is defined on the left surface 296a of the edge 296. The recess 292 is recessed rightward from the left surface 296a of the edge 296. A position of the recess 292 is fixed with respect to the cam part 290. As shown in FIG. 15, a right surface 296b of the edge 296 has a shape by which a width between the right surface 296h and the left surface 296a of the edge 296 increases in a clockwise direction as seeing the pivot axis RX1 from the left. The right surface 296b of the edge 296 is slidably in contact with a left surface at a lower portion of the link part 278. When the lever 286 is in. the dosed position, a portion where the width between the left surface 296a and the right surface 296b of the edge 296 is the smallest comes into contact with the link part 278. At this occasion, the driven roller 276 is pressed against the driving roller 274, When the lever 286 is in the open position, a portion where the width between the left surface 296a and the right surface 296h of the edge 296 is the largest comes into contact with the link part 278. Since the cam part 290 presses in the link part 278 against the biasing force of the biasing part 280, the link part 27$ pivots about the pivot shaft 278a. As a result, the driven roller 276 separates away from the driving roller 274.

As shown in FIG. 16, a fixing member 300 is fixed to the inner surface of the left main body 204b. The coupler 288 is inserted in the fixing member 300. The fixing member 300 is disposed between the inner surface of the left main body 204b and the left surface 296a of the cam part 290. A right surface 300a of the fixing member 300 faces the left surface 296a of the cam part 290. A protrusion 302 protruding rightward is arranged on the right surface 300a of the fixing member 300. A position of the protrusion 302 is fixed with respect to the left main body 204h. The protrusion 302 is given a shape corresponding to a shape of the recess .292 defined in the cam part 290. The protrusion 302 is configured to engage with the recess 292 when the lever 286 is in the closed position. When the protrusion 302 engages with the recess 292, the lever 286 is maintained in the closed position. When the lever 286 is operated by the operator to be moved from the closed position to the open position, the right surface 300a of the fixing member 300 warps toward the inner surface of the left main body 204b. Due to this, engagement of the protrusion 302 and the recess 292 is thereby released,

The coupler 288 extends through inside a third biasing member 304. The third biasing member 304 may for example be a compression spring, The third biasing member 304 is inserted in the fixing member 300 so as to surround the coupler 288. One end of the third biasing member 304 is in contact with the left surface 296a of the cam part. 290 and another end of the third biasing member 304 is in contact with the inner surface of the left main body 204b. The third biasing member 304 is configured to bias the cam part 290 rightward with respect to the left main body 204b. DUO to this, the lever 286 is pressed against the outer surfaces of the left main body 204b and the cover member 224. As a result, wobbling of the operating part 284 is suppressed.

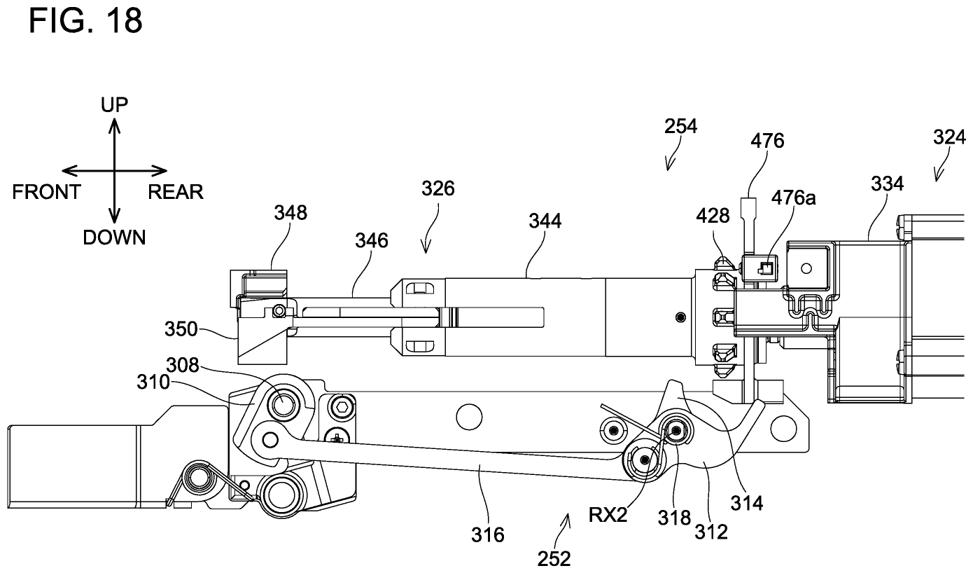

As shown in FIG. 18, the cutter unit 252 comprises a fixed cutter member 308, a movable cutter member 310, a first lever member 312, a second lever member 314, a link member 316, and a torsion spring 318. The fixed cutter member 308 and the movable cutter member 310 are disposed on a passage along which .the wire W is fed from the feeding part 260 to the guiding part 262. The fixed cutter member 308 comprises a hole 308a (see FIG. 17) through which the wire W extends. The movable, cutter member 310 is supported by the fixed cutter member 308 so as to be able to slide and pivot about the fixed cutter member 308. The movable cutter member 310 comprises a hole 310a (see FIG. 17) through which the wire W extends. When the movable cutter member 310 pivots in a direction D3 shown in FIG. 17 in a state of having the wire W inserted in both the hole 308a of the fixed cutter member 308 and the hole 310a of the movable cutter member 310, the wire W is thereby cut.

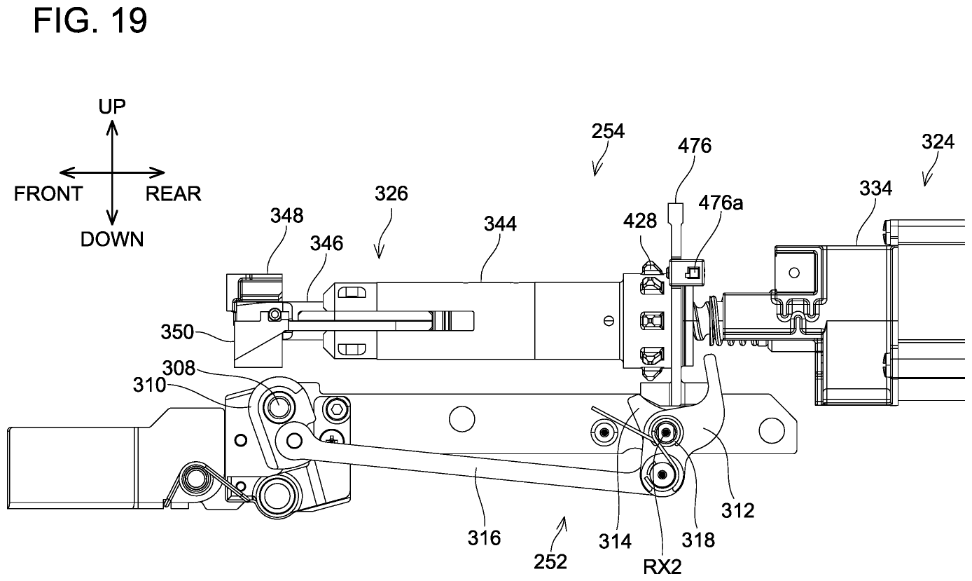

As shown in FIG, 18, the first lever member 312 and the second lever member 314 are fixed to each other. The first lever member 312 and the second lever member 314 are capable of pivoting about a pivot axis RX2. Lower ends of the first lever member 312 and the second lever member 314 are pivotably coupled to a rear end of the link member 316. A front end of the link member 316 is pivotably coupled to a lower end of the movable cutter member 310, The rear end of the link member 316 is biased frontward by a torsion spring 318. When the first lever member 312 and the second lever member 314 pivot in a direction along which the lower ends thereof move frontward, the link member 316 moves frontward. On the other hand, as shown in FIG. 19, when the first lever member 312 and the second lever member 314 pivot in a direction along which the lower ends thereof move rearward, the link member 316 moves rearward. Due to this, the wire W is cut.

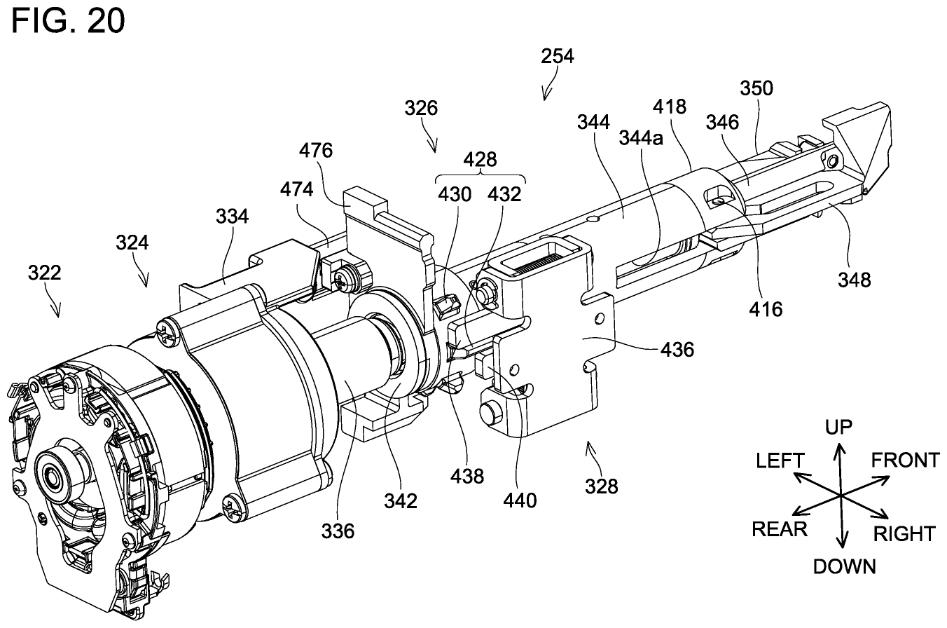

As shown in FIG. 20, the twisting Unit 254 comprises a twisting motor 322, a reduction gear unit 324, a retaining part 326, and a rotation restrictor 328. The twisting motor 322 may for example be a brushless motor. The twisting motor 322 has same configuration as the feeding motor 256. As shown in FIG. 10, the twisting motor 322 and the controller 220 are electrically connected by a fourth connecting cable 330. The fourth connecting cable 330 extends from the twisting motor 322 through an inner rear portion of the main body 204, further extends through inside of the grip 206 via a connecting position between the main body 204 and the grip 206, and through inside the battery receptacle 208 to the controller 220.

The reduction gear unit 324 shown in FIG. 20 is configured to decelerate rotation of the twisting motor 322 and transmit the same to the retaining part 326. The twisting motor 322 and the reduction gear unit 324 are fixed to the right main body 204a and the left main body 204h.

As shown in FIG, 21, the retaining part 326 comprises a bearing box 334, a carrier sleeve 336, a clutch plate 338, a screw shaft 340, an inner sleeve 342, an outer sleeve 344, a clamp shaft 346, a right clamp 348, and a left clamp 350.

The bearing box 334 is fixed to the reduction gear unit 324. The bearing box 334 rotatably supports the carrier sleeve 336 via a bearing 334a. Rotation is transmitted from the reduction gear unit 324 to the carrier sleeve 336. When the twisting motor 322 rotates forward, the carrier sleeve 336 rotates in a left-hand screw direction as seen from behind. When the twisting motor 322 rotates in reverse, the carrier sleeve 336 rotates in a right-hand screw direction as seen from behind.

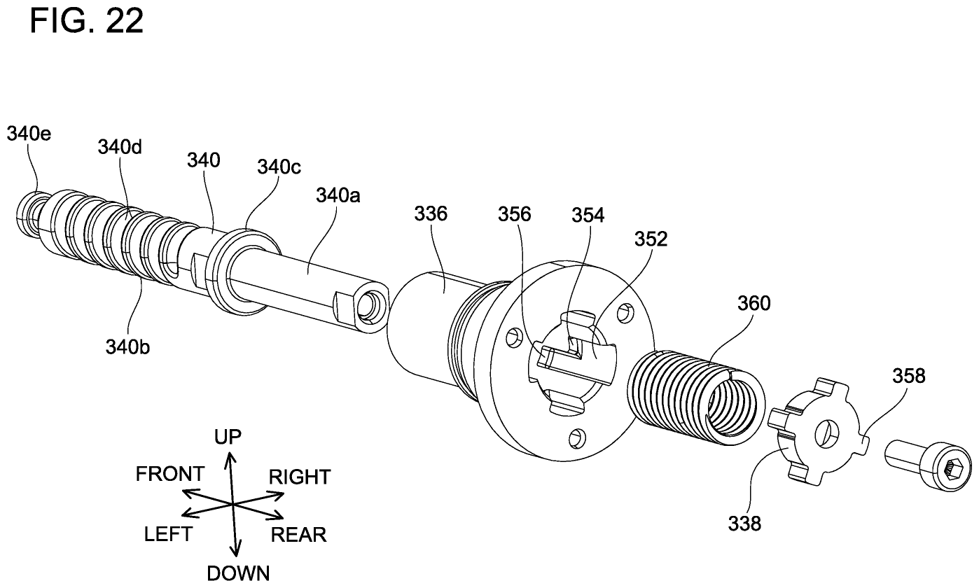

As shown in FIG. 22 a clutch groove 352 extending in the front-rear direction is defined on an inner circumferential surface at a rear portion of the carrier sleeve 336. A first wall 354 and a second wall 356 are arranged at a front end of the clutch groove 352. A distance from a rear end of the carrier sleeve 336 to the first wall 354 in the front-rear direction is smaller than a distance from the rear end of the carrier sleeve 336 to the second wall 356 in the front-rear direction. The clutch plate 338 is accommodated in the carrier sleeve 336A. clutch piece 358 corresponding to the clutch groove 352 is arranged on the clutch plate 338. The clutch plate 338 is biased rearward with respect to the carrier sleeve 336 by a compression spring 360 accommodated in the carrier sleeve 336. in a normal state, the clutch plate 338 is capable of moving forward with respect to the carrier sleeve 336 to a position at which the clutch piece 358 comes into contact with the first wail 354 of the clutch groove 352. When the wire W is to be twisted, the carrier sleeve 336 rotates in the left-hand screw direction with respect to the clutch plate 338 as seen from behind, thus the clutch plate 338 is capable of moving forward with respect to the Carrier sleeve 336 to a position at which the clutch piece 358 comes into contact with the second wall 356 of the clutch groove 352.

A rear part 340a of the screw shaft 340 is inserted into the carrier sleeve 336 from the front side, and is fixed to the clutch plate 338. A flange 340c projecting in a radial direction is arranged between the rear part 340a and a front part 340b of the screw shaft 340. A spiral ball groove 340d is defined in an outer circumferential surface of the front part 340b of the screw shaft 340. An engaging part 340e with a smaller diameter than the front part 340h is arranged at a front end of the screw shaft 340.

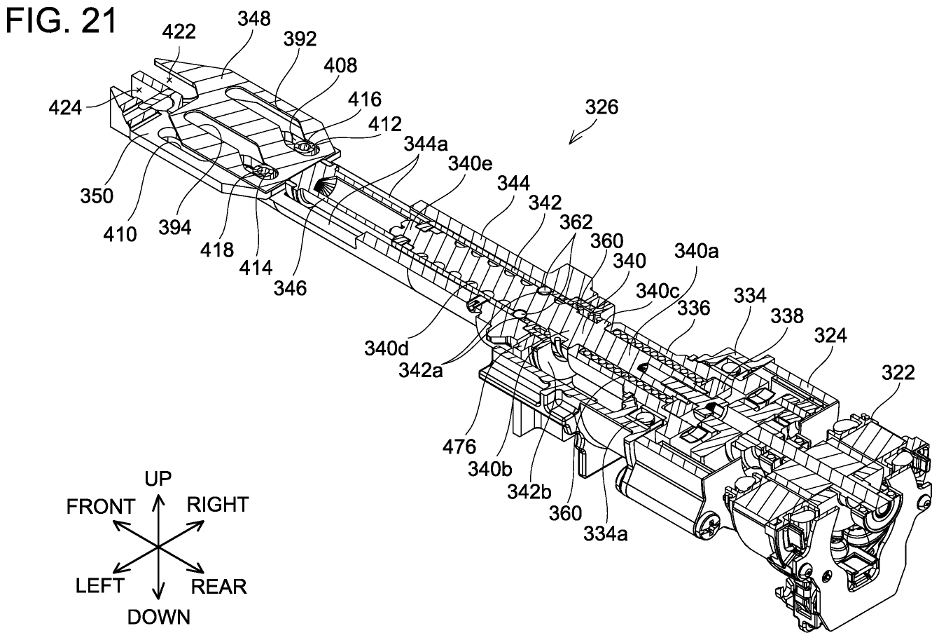

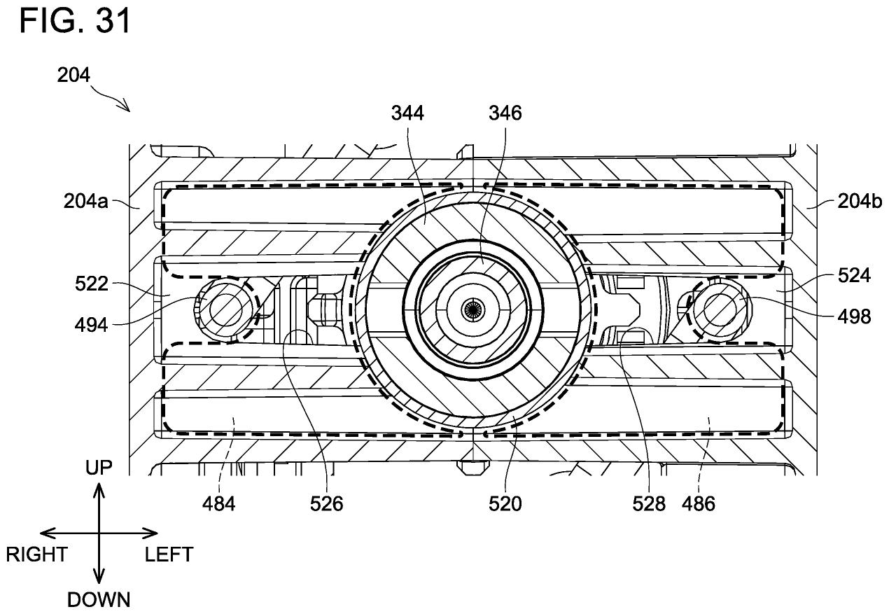

As shown in FIG. 21, the compression spring 360 is attached to the front part 340b of the screw shaft 340. The front part 340b of the screw shaft 340 is inserted into the inner sleeve 342 from behind. The inner sleeve 342 comprises a ball hole 342a for retaining balls 362. The balls 362 fit in the ball groove 340d of the screw shaft 340. A flange 342b projecting in the radial direction is arranged at a rear end of the inner sleeve 342. The inner sleeve 342 is inserted into the outer sleeve 344 from behind. The outer sleeve 344 is fixed to the inner sleeve 342. When rotation of the outer sleeve 344 is allowed by the rotation restrictor 328 (see FIG. 20), the inner sleeve 342 and the outer sleeve 344 rotate integrally as the screw shaft 340 rotates. On the other hand, when the rotation of the outer sleeve 344 is prohibited by the rotation restrictor 328 (see FIG. 18), the inner sleeve 342 and the outer sleeve 344 move in the front-rear direction with respect to the screw shaft 340, Specifically, when. the twisting motor 322 rotates forward and the screw shaft 340 rotates in the left-hand screw direction as seen from behind, the inner sleeve 342 and the outer sleeve 344 move forward with respect to the screw shaft 340. Further, when the twisting motor 322 rotates in reverse and the screw shaft 340 rotates in the right-hand screw direction as seen from behind, the inner sleeve 342 and the outer sleeve 344 move rearward with respect to the screw shaft 340. A slit 344a extending rearward from a front end of the outer sleeve 344 is defined in a front portion of the outer sleeve 344. As shown in FIG. 31, a part of an outer circumferential surface of the outer sleeve 344 is surrounded by a bearing 520. The bearing 520 has a loop shape. A diameter of an inner circumferential surface of the bearing 520 is slightly greater than a diameter of the outer circumferential surface of the outer sleeve 344. Due to this, the outer sleeve 344 can move in the front-rear direction inside the bearing 520. The bearing 520 is retained by a right bearing retaining part 522 arranged on the inner surface of the right main body 204a and a left bearing retaining part 524 arranged on the inner surface of the left main body 204b. Due to this, a position of the bearing 520 with respect to the main body 204 in the front-rear direction is fixed. The outer sleeve 344 is inserted between the right bearing retaining part 522 and the left bearing retaining part 524.

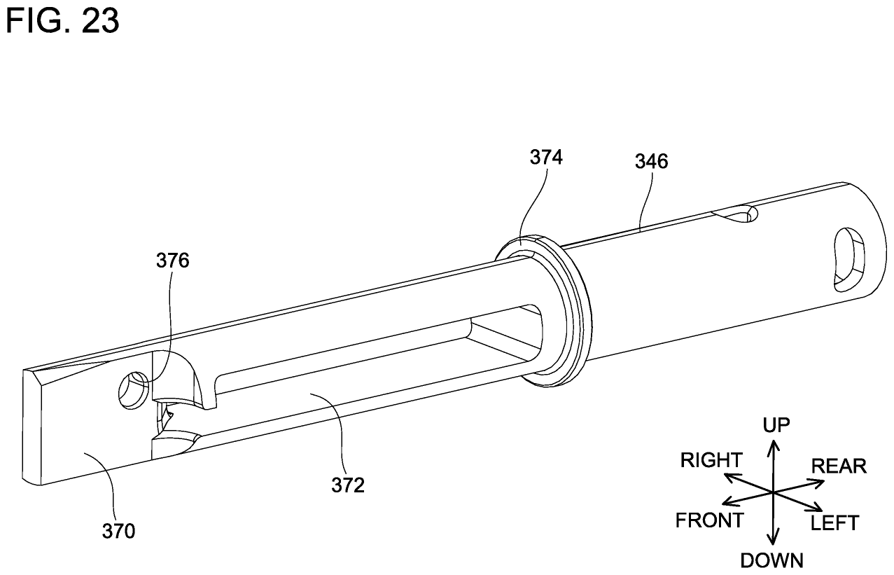

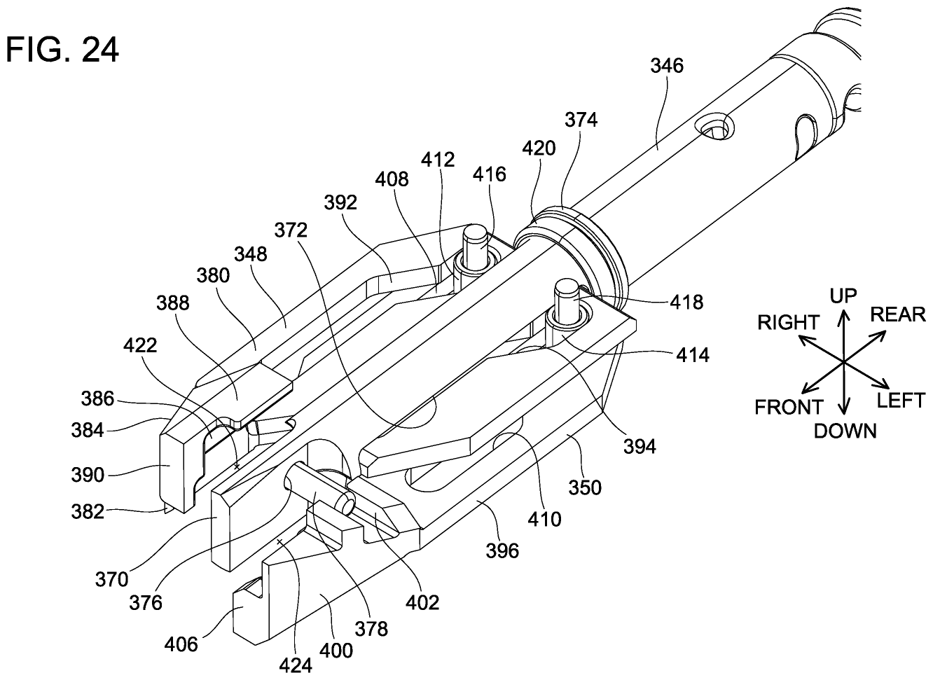

The clamp shaft 346 is inserted into the inner sleeve 342 from the front side. The engaging part 340e of the screw shaft 340 is inserted in a rear end of the clamp shaft 346. The clamp shaft 346 is fixed to the screw shaft 340. As shown in FIG. 23, the clamp shaft 346 comprises a flat plate part 370, an opening 372, and a flange 374. The flat plate part 370 is disposed at a front end of the clamp shaft 346, and has a flat plate shape extending in the up-down. direction and the front-rear direction. The flat plate part 370 has a hole 376 into which a pin 378 (see FIG. 24) is to be fitted. The opening 372 is disposed behind the flat plate part 370, The opening 372 penetrates the clamp shaft 346 in the left-right direction and extends in the front-rear direction. The flange 374 is disposed behind the opening 372 and. protrudes in the radial direction.

As shown in. FIG. 24, the right clamp 348 is attached to the clamp shaft 346 so as to penetrate the opening 372 of the clamp shaft 346 from right to left. The left clamp 350 is attached to the clamp shaft 346 so as to penetrate the opening 372 of the clamp shaft 346 from left to right below the right clamp 348.

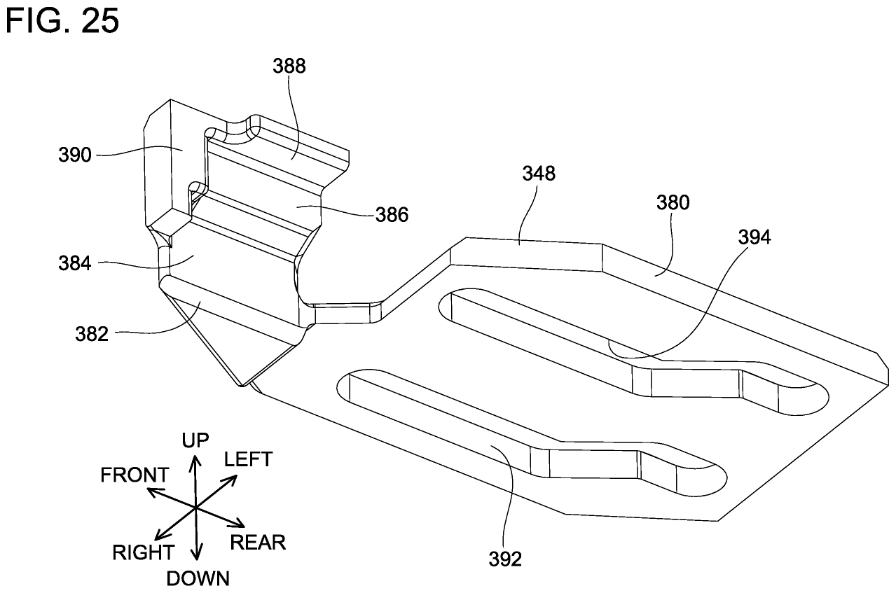

As shown in FIG. 25, the right clamp 348 comprises a base part 380, a first projection 382, a second projection 384, a contacting part 386, an upper guard 388, and a front guard 390. The base part 380 has a flat plate shape extending in the front-rear direction and the left-right direction. The base part 380 comprises cam holes 392,394. The earn holes 392,394 each have a shape extending frontward toward a front end from a rear end, bending to extend toward tire right front side, and bending again to extend frontward. The first projection 382 projects downward from a right front end of the base part 380. The second projection 384 projects upward from the right front end of the base part 380. The contacting part 386 protrudes leftward from an upper end of the second projection 384. lire upper guard 388 protrudes leftward from air upper end of the contacting part 386. The front guard 390 protrudes leftward from front ends of the second projection 384 and the contacting part 386.

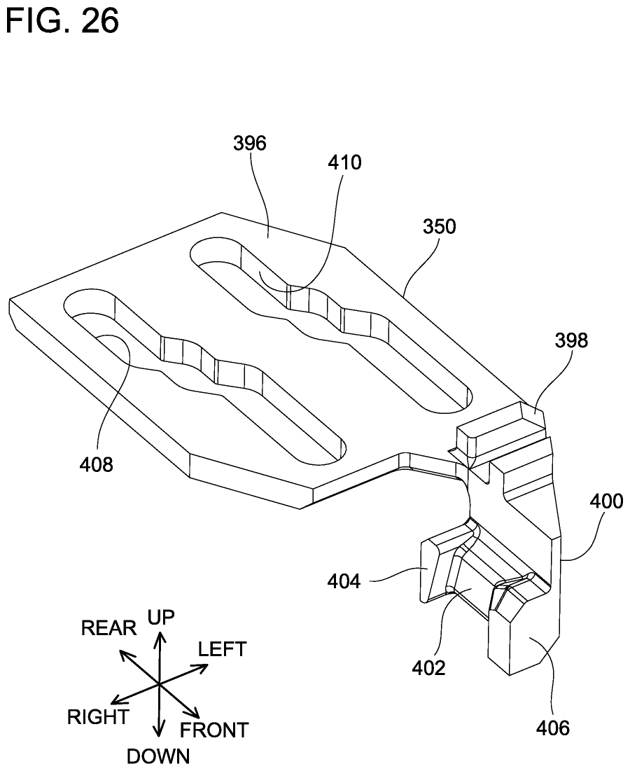

As shown in FIG. 26, the left clamp 350 comprises a base part 396, a pin retaining part 398, a first projection 400, a contacting part 402, a rear guard 404, and a front guard 406. The base part 396 has a flat plate shape extending in the front-rear direction and the left-right direction. The base part 396 comprises cam holes 408, 410. The cam holes 408. 410 each have a shape extending frontward toward a front end from a rear end, bending to extend toward the left front side, bending again to extend frontward, then bending to extend toward the left front side, and further bending again to extend frontward. The pin retaining part 398 projects upward from a left front end of the base part 396. The pin retaining part 398 slidably retains the pin 378 (see FIG. 24). T he first projection 400 projects downward from the left front end of the base part 396. The contacting part 402 projects rightward from a lower end of the first projection 400. The rear guard 404 protrudes rightward from a rear end of the contacting part 402. The front guard 406 protrudes rightward from a front end of the contacting part 402.

As shown in FIG. 24, in a state where the right clamp 348 and the left clamp 350 are attached to the clamp shaft 346, a cam sleeve 412 is inserted in the cam holes 392,408 and a cam sleeve 414 is inserted in the cam holes 394,410. Further, a support pin 416 is inserted in the C3m sleeve 412, and a support pin 418 is inserted in the cam sleeve 414. An annular cushion 420 is attached between the right clamp 348 and the left clamp 350 and the flange 374 of the clamp shaft 346.

As shown in FIG. 20, in a state where the clamp shaft 346 is attached to the inner sleeve 342, the right clamp 348 and the left clamp 350 are inserted in the slit 344a of the outer sleeve 344. and the support pins 416, 418 are coupled to the outer sleeve 344. When the damp shaft 346 moves in the front-rear direction with respect to the outer sleeve 344, the cam sleeve 412 attached to the support pin 416 moves in the front-rear direction inside the cam holes 392,408 and the cam sleeve 414 attached to the support pin 418 moves in the front-rear direction inside the cam holes 394, 410, by winch the right clamp 348 and the left clamp 350 move in the left-right direction.

As shown in FIG. 24, in an initial state where the clamp shaft 346 protrudes frontward from the outer sleeve 344, the right clamp 348 is positioned at farthest right with respect to the clamp shaft 346. In this state, a right wire passage 422 through which the wire W can extend is. secured between the second projection 384 of the right clamp 348 and the flat plate part 370 of the clamp shaft 346, and an upper side of the right wire passage 422 is covered by the upper guard 388. This state of the right clamp 348 is termed a fully opened state. From this state, when the outer sleeve 344 moves forward with respect to the clamp shaft 346, the right clamp 348 moves leftward with respect to the clamp shaft 346. In this state, the wire W is held between a lower end of the contacting part 386 of the right clamp 348 and an upper end of the flat plate part 370 of the clamp shaft 346, and the front side of the right wire passage 422 is covered by the front guard 390. This state of the right clamp 348 is termed a fully closed state.

In the initial state where the clamp shaft 346 protrudes frontward from the outer sleeve 344, the left clamp 350 is positioned at farthest left with respect to the clamp shaft 346. In this state, a left wire passage 424 through which the wire W can extend is secured between the first projection 400 of the left clamp 350 and the fiat plate part 370 of the clamp shaft 346. This state of the left clamp 350 is termed a fully opened state. From this state, when the outer sleeve 344 moves forward with respect to the clamp shaft 346, the left clamp 350 moves rightward with. respect to the clamp shaft 346. In this state as well, the wire W can extend through the left wire passage 424, however, a rear portion of the left wire passage 424 is covered by the rear guard 404 and a front portion of the left wire passage 424 is covered by the front guard 406. This state of the left clamp 350 is termed a half-opened state. From this state, when the outer sleeve 344 further moves forward with respect to the clamp shaft 346, the left clamp 350 further moves rightward with respect to the clamp shaft 346. In this state, the wire W is held between an upper end of the contacting part 402 of the left clamp 350 and a lower end of the flat plate part 370 of the clamp shaft 346. This state of the left clamp is termed a fully closed state.

The wire W fed from the feeding part 260 to the guiding part 262 passes through the left wire passage 424 before it reaches the guiding part 262. Due to this, when the left clamp 350 enters the fully closed state and the wire W is cut by the cutter unit 252, a trailing end of the wire W wrapped around the rebars R is retained by the left clamp 350 and the clamp shaft 346.

Further, the wire W guided in the guiding part 262 passes through the right wire passage 422. Due to this, when the right clamp 348 enters the fully closed state, a tip end of the wire W wrapped around the rebars R. is retained by the right clamp 348 and the clamp shaft 346.

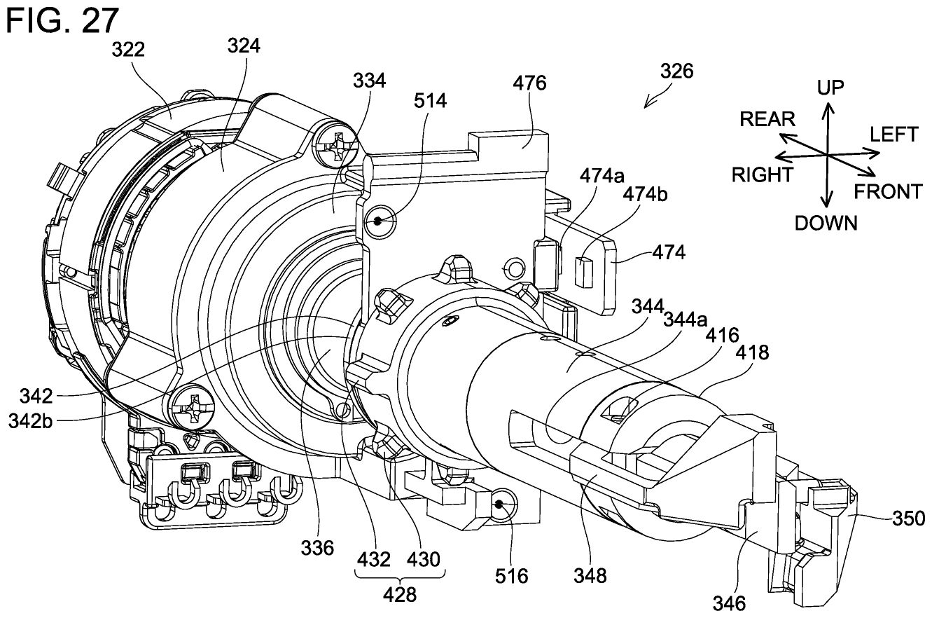

As shown in FIG. 27, eight fins 428 are arranged on a rear outer circumferential surface of the outer sleeve 344. The fins 428 extend in the front-rear direction. In the present embodiment, the eight fins 428 are arranged with 45-degrees intervals on the outer circumferential surface of the outer sleeve 344. Further, in the present embodiment, the eight fins 428 comprise seven short fins 430 and one long fin 432. A length of the long fin 432 in the front-rear direction is longer than a length of the short fins 430 in the front-rear direction. In the front-rear direction, a position of a rear end of the long fin 432 is same as positions of rear ends of the short fins 430. In the front-rear direction, a position of a front end of the long fin 432 is located frontward than positions of front ends of the short fins 430.

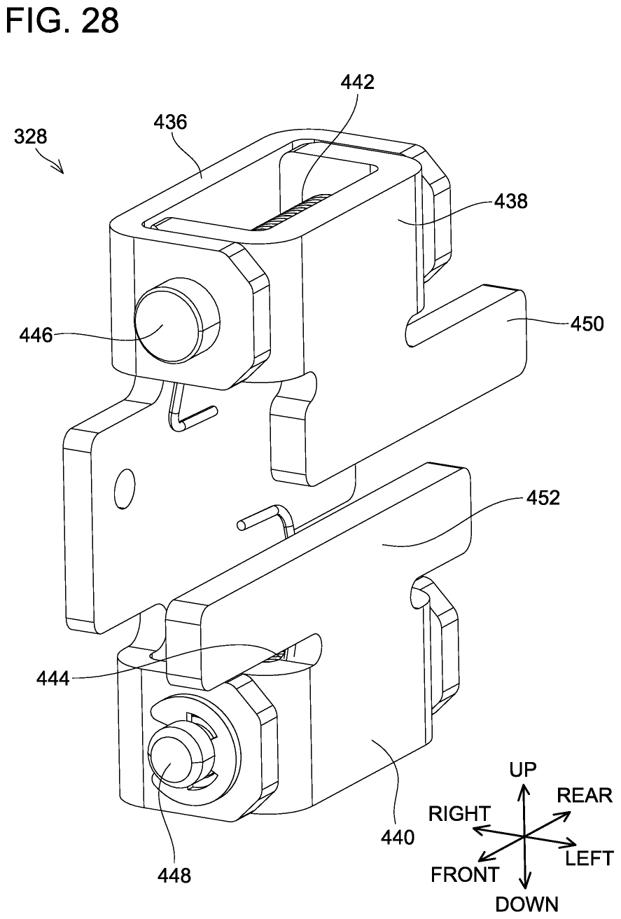

As shown in FIG. 20, the rotation restrictor 328 is disposed. at a. position corresponding to the fins 428 of the outer sleeve 344. The rotation restrictor 328 cooperates with the fins 428 to allow or prohibit rotation of the outer sleeve 344. As shown in FIG. 28, the rotation restrictor 328 comprises a base member 436, an upper stopper 438, a lower stopper 440, and torsion springs 442, 444. The base member 436 is fixed to the right main body 204a. The upper stopper 438 is pivotably supported at an upper portion of the base member 436 via a pivoting portion 446. The upper stopper 438 comprises a restriction piece 450. The restriction piece 450 is positioned at a lower portion of the upper stopper 438. The torsion spring 442 biases the upper stopper 438 in a direction of opening outward (that is, in a direction along which the restriction piece 450 separates away from the base member 436). The lower stopper 440 is pivotably supported at a lower portion of the base member 436 via a pivoting portion 448. The lower stopper 440 comprises a restriction piece 452. The restriction piece 452 is positioned at an upper portion of the lower stopper 440. A rear end of the restriction piece 452 is disposed frontward than a rear end of the restriction piece 450. A front end of the restriction piece 452 is disposed frontward than a front end of the restriction piece 450. The torsion spring 444 biases the lower stopper 440 in a direction of opening outward. (that is, in a direction along which the restriction piece 452 separates away from the base member 436).

When the twisting motor 322 rotates forward with respect to the upper stopper 438 and the screw shaft 340 rotates in the left-hand screw direction as seen from behind, the rotation of the outer sleeve 344 is prohibited by the upper stopper 438 when the fins 428 of the outer sleeve 344 come into contact with the restriction piece 450. On the other hand, when the twisting motor 322 rotates in reverse and the screw shaft 340 rotates in the right-hand screw direction as seen from behind, the fins 428 of the outer sleeve 344 pushes in the restriction piece 450 even after they come into contact with the restriction piece 450. In this case, the upper stopper 438 does not prohibit the rotation of the outer sleeve 344.

When the twisting motor 322 rotates forward with respect to the lower stopper 440 and the screw shaft 340 rotates in the left-hand screw direction as seen from behind, the fins 428 of the outer sleeve 344 push in the restriction piece 452 even after they come into contact with the restriction piece 452. In this case, the lower stopper 440 does not prohibit the rotation of the outer sleeve 344. On the other hand, When the screw shaft 340 rotates in the right-hand screw direction as seen from behind, the rotation of the outer sleeve 344 is prohibited by the lower stopper 440 when the fins 428 of the outer sleeve 344 come into contact with the restriction piece 452.

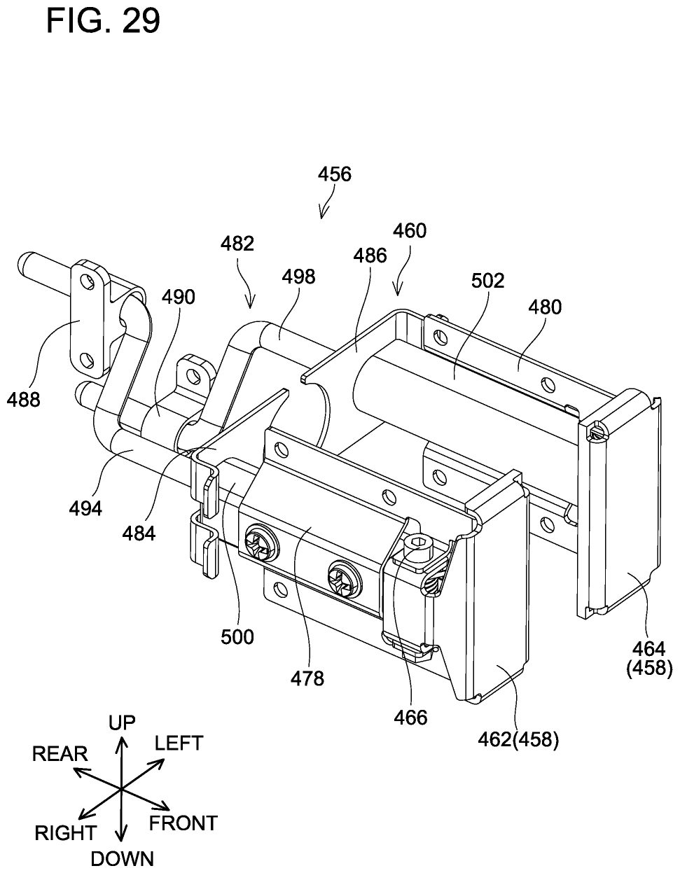

As shown in FIG. 9, the rebar tying tool 202 further comprises a rebar pusher 456. As shown in FIG. 29, the rebar pusher 456 comprises a contacting member 458 and a pushing part 460. The pushing part 460 is configured to push out the contacting member 458 forward with respect to the main body 204. The pushing part 460 comprises a push plate 476 (see FIG. 27), base members 478, 480, a push rod 482, guide plates 484, 486, and rod holders 488, 490.

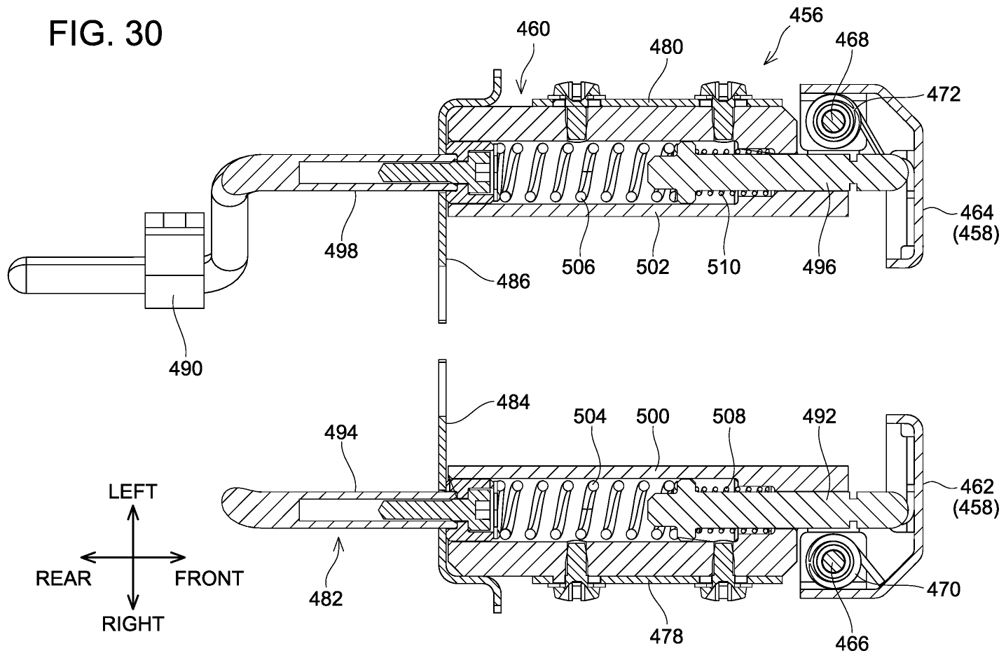

The contacting member 458 is disposed close to the front end of the main body 204. The contacting member 458 is disposed frontward than the twisting unit 254. The contacting member 458 comprises a first contacting part 462 and a second contacting part 464. The first contacting part 462 and the second contacting part 464 are disposed apart along the left-right direction. The first contacting part 462 and the second contacting part 464 are disposed separately. A shape of the first contacting part 462 is in a symmetric relationship with a shape of the second contacting part 464 with respect to a plane perpendicularly intersecting the left-right direction. The first contacting part 462 and the second contacting part 464 are supported by the base members 478, 480 so as to be pivotable about pivot axes 466, 468 (see FIG. 30) extending in the up-down direction, The base member 478 is fixed to the right main body 204a. The base member 480 is fixed to the left main body 204b. As shown in FIG. 30, torsion springs 470, 472 are attached to the pivot axes 466, 468, The torsion spring 470 causes a rearward biasing force acting in a closing direction to be applied to the first contacting part 462 with respect to the base member 478 by its elastic restoration force when the first contacting part 462 pivots frontward in an opening direction with respect to the base member 478. The torsion spring 472 causes a rearward biasing force acting in a closing direction to be applied to the second contacting part 464 with respect to the base member 480 by its elastic restoration force when the second contacting part. 464 pivots frontward. in an opening direction with respect to the base member 480.

The push rod 482 comprises front push rods 492, 496, rear push rods 494, 498, rod guides 500, 502. first compression springs 504, 506, and second compression springs 508, 510, The rod guides 500, 502 are fixed to the base members 478, 480. The front push rods 492, 496 are inserted into the rod guides 500, 502. from behind, and protrude frontward than front ends of the rod guides 500, 502. A front end of the front push rod 492 is disposed behind the first contacting part 462 and facing a rear surface of the first contacting part 462. A front end of the front push rod 496 is disposed behind the second contacting part 464 and facing a rear surface of the second contacting part 464. The front push rods 492., 496 are configured to move in the front-rear direction with respect to the main body 204 by being guided by the rod guides 500, 502. The rear push rods 494, 498 are inserted into the rod guides 500, 502 from behind. The rear push rod 494 is disposed behind the front push rod 492 and facing the front push rod 492, and the rear push rod 498 is disposed behind the front push rod 496 and facing the front push rod 496. The rear push rods 494, 498 are configured to move in the front-rear direction with respect to the main body 204 by being guided by the rod guides 500, 502. The first compression springs 504, 506 and the second compression springs 508, 510 are accommodated inside the rod guides 500, 502. The first compression springs 504, 506 couple the front push rods 492, 496 with the rear push rods 494, 498. The first compression springs 504, 506 cause an elastic restoration force to be applied when intervals between the front push rods 492, 496 and the rear push rods 494, 498 are decreased. The second compression springs 508, 510 bias the front push rods 492, 496 rearward with respect to the rod guides 500, 502. Spring stiffness of the second compression springs 508, 510 is smaller than spring stiffness of the first compression springs 504, 506. As Shown in FIG. 29, the rear push rod 494 extends rearward from a front end to a rear end, bends to extend toward the left upper side, and further bends to extend rearward. The rear push rod 498 extends rearward from a front end to a rear end, bends to extend toward the right lower side, and further bends to extend rearward. As shown in FIG. 31, the rear push rods 494, 498 extend through a groove 52.6 defined in the right bearing retaining part 522 and a groove 528 defined in the left bearing retaining part. 524. As shown in FIG. 29, the rod holders 488, 490 are configured to guide movements of the rear push rods 494, 498 in the front-rear direction. The guide plate 484 and the rod holder 488 are fixed to the right main body 204a. The guide plate 486 and the rod holder 490 are fixed to the left main body 204b.

As shown in FIG. 31, the guide plates 484, 486 surround a part of the outer circumferential surface of the outer sleeve 344. In FIG. 31, the guide plates 484, 486 are depicted by broken lines. The guide plates 484, 486 are disposed frontward than the right bearing retaining part 522 and the left bearing retaining part 524. When seeing the guide plates 484, 486 from the front side, the guide plates 484, 486 close the groove 526 recessed rightward from a left end of the right bearing, retaining part 522 and the groove 528 recessed leftward from a right end of the left. bearing retaining part 524 from the front side within ranges that do not overlap with the rear push rods 494, 498. Due to this, foreign particles such as iron powder generated from the rebars R can be suppressed from entering the grooves 526, 528 rearward front the front side.

As shown in FIG. 27, the push plate 476 is disposed between the rear end of the outer sleeve 344 and the flange 342b of the inner sleeve 342. The push plate 476 is configured to move in the front-rear direction with respect to the main body 204 following movements of the outer sleeve 344 and the inner sleeve 342 in the front-rear direction. As shown in FIGS. 18 and 19, a lower end of the push plate 476 is disposed at a position corresponding to the first lever member 312 and the second lever member 314 of the cutter unit 252. Due to this, when the push plate 476 moves frontward, the lower end of the push plate 476 comes into contact with the second lever member 314 and causes the second lever member 314 to pivot frontward. As shown in FIG. 27, the push plate 476 comprises a recess 514 defined at a position facing the rear end of the rear push rod 494 and a recess 516 defined at a position facing the rear end of the rear push rod 498. The recess 514 is positioned at a right upper portion of a front surface of the push plate 476. The recess 516 is positioned at a left lower portion of the front surface of the push plate 476.

When the push plate 476 moves frontward with respect to the main body 204, the rear ends of the rear push rods 494, 498 shown in FIG. .29 enter the recesses 514, 516 of the push plate 476. From this state, when the push plate 476 further moves frontward, the rear push rods 494, 498 are pushed in frontward, and the front push rods 492, 496 are pushed out frontward via the first compression springs 504, 506 shown in FIG, 30. Due to this, the first contacting part 462 and the second contacting part 464 pivot frontward in the opening direction, and are pressed against the rebus R.

As shown in FIGS. 18 and 19, the push plate 476 has a permanent magnet 476a attached thereto. As shown in FIG. 27, a sensor substrate 474 is disposed in the bearing box 334, corresponding to the permanent magnet 476a. The sensor substrate 474 has magnetic sensors 474a, 474b configured to detect magnetics of the permanent magnet 476a. The magnetic sensor 474a is disposed at a position facing the permanent magnet 476a when the twisting unit 254 is in the initial state. The controller 220 determines whether the twisting unit 254 is in the initial state by using the permanent magnet 476a and the magnetic sensor 474a. The magnetic sensor 474b is disposed at a position facing the permanent magnet 476a when the right clamp 348 is in the fully closed state and the left clamp 350 is in the half-opened state. The controller 220 determines whether the right clamp 348 is in the fully closed state and the left clamp 350 is in the half-opened state by using the permanent magnet 476a and the magnetic sensor 474h.

The magnetic sensors 474a, 474h and the controller 2.20 are electrically connected by seventh connecting cables 475 (see FIG. 10). As shown in FIG. 10, the seventh connecting cables 475 extend from the sensor substrate 474 and on the left side of the twisting unit 254, further extend inside the grip 206 via the connecting position between the main body 204 and the grip 206, and through inside the battery receptacle 208 to the controller 220.

Next, the tying operation of the rebar tying tool 202 will be described. The rebar tying tool 202 is configured to perform the tying operation when the trigger 212 is operated by the operator. Upon When the rebar tying tool 202 performs the tying operation, a feed-out process, a tip end. retaining process, a pullback process, a trailing end retaining process, a cutting process, a tensioning process, a twisting process, and a returning process are executed.

(Feed-Out Process)

From the initial state of the rebar tying tool 202, when the feeding motor 256 shown in FIG. 14 rotates forward (that is, rotates in a direction D1 shown in FIG. 14), the feeding unit 250 feeds out the wire W wound on the reel 232 by a predetermined length. As shown in FIG. 17, the tip end of the wire W extends through the fixed cutter member 308, the movable cutter member 310, the left wire passage 424 (see FIG. 24), the guiding part 262, and the right wire passage 422 (see FIG. 24) in this order. Due to this, the wire W is wrapped around the rebars R in the loop shape. When the feed-out of the wire W is completed, the feeding motor 256 stops.

(Tip End Retaining Process)

After completion of the feed-out process, when the twisting motor 322 shown in FIG. 20 rotates forward, the screw shaft. 340 rotates in the left-hand screw direction. At this occasion, the outer sleeve 344 is prohibited from rotating in the left-hand screw direction by the rotation. restrictor 328. Due to this, the outer sleeve 344 moves forward with respect to the main body 204 and the clamp shaft 346 together with the inner sleeve 342. Due to this, the right clamp 348 enters the fully closed state and the left clamp 350 enters the half-opened. state. As a result, the tip end of the wire W is retained by the right clamp 348 and the clamp shaft 346. After this, the twisting motor 322 stops.

(Pullback Process)

After completion of the tip end retaining process, when the feeding motor 256 shown in FIG. 14 rotates in reverse (that is, in the direction D2 shown in FIG. 14), the feeding unit 250 pulls back the wire W wrapped around the rebus R. Since the tip end of the wire W is retained by the right clamp 348 and the clamp shaft 346, the diameter of the wire W around the rebars R decreases. When the pullback of the wire W is completed, the feeding motor 256 stops.

(Trailing End Retaining Process)

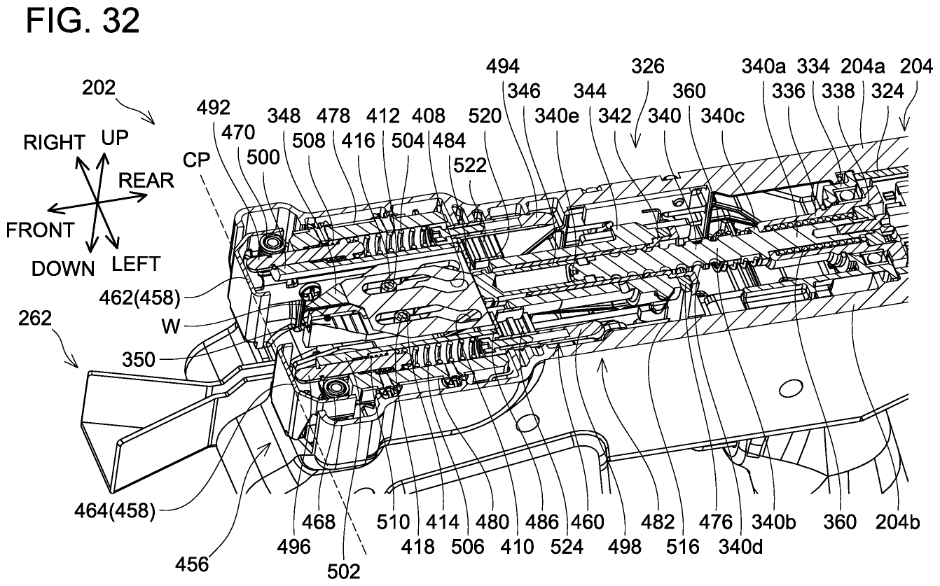

After completion of the pullback process, when the twisting motor 322 shown in FIG. 2.0 rotates forward, the screw shaft 340 rotates in the left-hand screw direction. At this occasion, the outer sleeve 344 is prohibited from rotating in the left-hand screw direction by the rotation restrictor 328. Due to this, the outer sleeve 344 further moves forward with respect to the main body 204 and. the clamp shaft 346 together with the inner sleeve 342. Due to this, as shown in FIG. 32, the left clamp 350 enters the fully closed state. As a result, the trailing end of the wire W is retained by the left. clamp 350 and the clamp shaft 346.

(Cutting Process)

After completion of the trailing end retaining process, when the twisting motor 322 shown in FIG. 20 further rotates forward, the screw shaft 340 rotates in the left-hand screw direction. At this occasion, the outer sleeve 344 is prohibited from rotating in the left-hand screw direction by the rotation restrictor 328. Due to this, the outer sleeve 344 further moves forward with respect to the main body 204 and the damp shaft 346 together with the inner sleeve 342, and the push plate 476 presses down the upper end of the second lever member 314 frontward as shown in FIG. 19. Due to this, the wire W is cut by the fixed cutter member 308 and the movable cutter member 310.

(Tensioning Process)

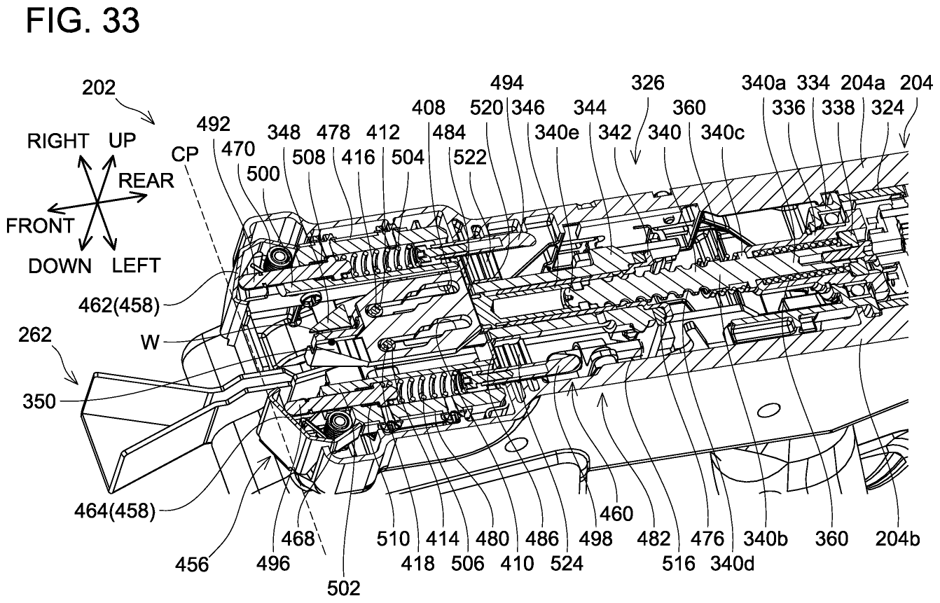

After completion of the cutting process, When the twisting motor 322 shown in FIG. 20 further rotates forward, the screw shaft 340 rotates in the left-hand screw direction. Since the outer sleeve 344 is prohibited from rotating in the left-hand screw direction by the rotation restrictor 328, the outer sleeve 344 further moves forward with respect to the main body 204 and the clamp shaft 346 together with the inner sleeve 342. After this, the rear ends of the rear push rods 494, 498 shown in FIG. 29 enter the recesses 514, 516 of the push plate 476 shown in FIG. 27. From this state, when the outer sleeve 344 and the inner sleeve 342 further move forward with respect to the main body 204 and the clamp shaft 346, the push plate 476 pushes out the rear push rods 494, 498 frontward. Due to this, as shown in FIG. 33, the rear push rods 494, 498 move forward, the front push rods 492, 496 move forward by the second compression springs 508, 510 being contracted, and the first contacting part 462 and the second contacting part 464 pivot frontward in the opening direction with respect to the base members 478, 480. Due to this, the rebars R are pushed out frontward with respect to the main body 204 (that is, the main body 204 is pushed back rearward relatively with respect to the rebars R), and the rebars R and the contacting position CP between the first contacting part 462 and the second contacting part 464 move apart.

from the retaining position of the wire W retained by the right clamp 348, the left clamp 350, and the clamp shaft 346. As a result, the wire W wrapped around the rebars R is thereby pulled. In the present embodiment, the contacting position CP moves frontward with respect to the main body 204.

(Twisting Process)

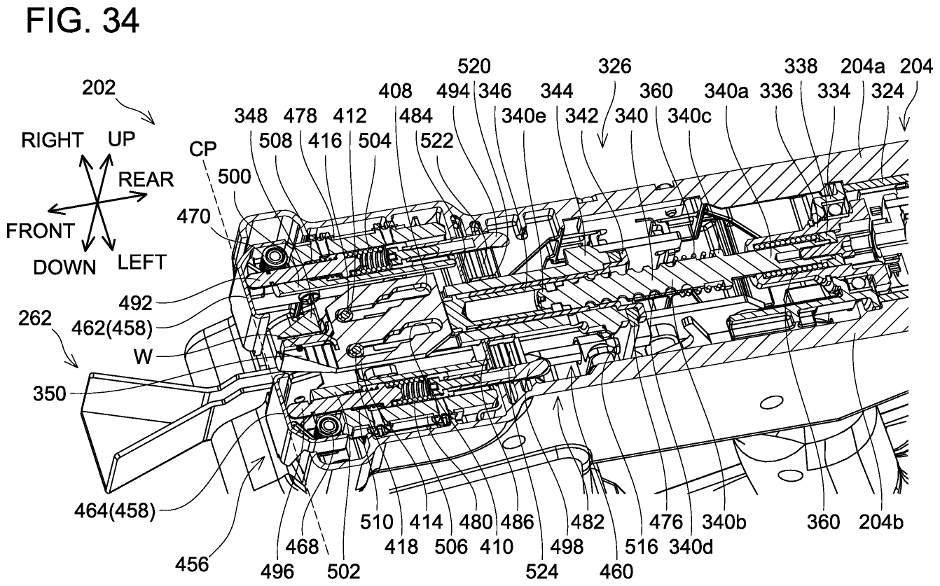

After completion of the tensioning process, when the twisting motor 322 shown in FIG. 20 further rotates forward, the screw shaft 340 rotates in the left-hand screw direction. At this occasion, the outer sleeve 344 is allowed to rotate in the left-hand screw direction by the rotation restrictor 328, thus the outer sleeve 344, the inner sleeve 342, the clamp shaft 346, the right clamp 348, and the left clamp 350 rotate in the left-hand screw direction integrally. Due to this, the wire W wrapped around the rebars R is twisted. As the wire W is twisted, the twisting allowance of the wire W becomes shorter, thus the right clamp 348, the left clamp 350, and the clamp shalt 346 that are retaining the wire W are drawn toward the rebars R, and. the main body 204 is drawn frontward toward the rebars R. As shown in FIG. 34, the first contacting part 462 and the second contacting part 464 pivot rearward in the closing direction with respect to the base members 478, 480 as a result and return to the initial positions, and the contacting position CP moves relatively rearward with respect to the main body 204. At this occasion, the front push rods 492, 496 move rearward, the second compression springs 508, 510 expand, and the first compression springs 504, 506 contract. From this state, when the wire W is further twisted, the clutch plate 338 shown in FIG. 22 moves forward against the biasing force of the compression spring 360 to a position at which the clutch piece 358 comes into contact with the second wall 356 of the clutch groove 352. Due to this, the screw shaft 340, the outer sleeve 344, the inner sleeve 342, the clamp shaft 346, the right damp 348, and the left clamp 350 move forward with respect to the main body 204. As a result, the retaining position of the retained wire W moves relatively frontward with respect to the main body 204. When the twisting of the w ire W is completed, the twisting motor 322 stops.

(Returning Process)

After completion of the twisting process, when the twisting motor 322 shown in FIG. 20 rotates in reverse, the screw shaft 340 rotates in the right-hand screw direction. At this occasion, the outer sleeve 344 is prohibited from rotating in the right-hand screw direction by the rotation restrictor 328. Due to this, the outer sleeve 344 retracts back with respect to the main body 204 and the clamp shaft 346 together with the inner sleeve 342. The left clamp 350 enters the fully opened state after being in the hall-opened state, and the right clamp 348 enters the fully opened state. When the rotation in the right-hand screw direction is allowed by the rotation restrictor 328. the outer sleeve 344, the inner sleeve 342, the clamp shaft 346, the right clamp 348, and the left damp 350 rotate in the right-hand screw direction integrally. When the long fin 432 comes into contact with the lower stopper 440, the rotation of the outer sleeve 344 is prohibited again. Due to this, the outer sleeve 344 returns to an angle of the outer sleeve 344 in the initial state. After this, the outer sleeve 344 retracts back again with respect to the main body 204 and the clamp shaft 346 together with the inner sleeve 342. When the twisting unit 254 returns to toe initial state, the twisting motor 322 stops.

In the present embodiment, the rebar tying tool 202 further comprises: the accommodating part main body 222 disposed downward than the twisting unit 254, wherein the rear surface 222a is disposed on the accommodating part main body 222; the battery receptacle 208 disposed downward than the grip 206 and configured to accommodate the controller 220; and the first connecting cable 240 that electrically connects the indicator 234 and the controller 220. As shown in FIG. 10, the accommodating part main body 222 is coupled to the battery receptacle 208 via the coupler 209. The first connecting cable 240 extends from the accommodating part main body 222 to the battery receptacle 208 via the coupler 209. In the above configuration, the first connecting cable 240 extending from toe accommodating part main body 222 to the battery receptacle 208 can be arranged without extending it through the twisting unit 254. Thus, the first connecting cable 240 can be suppressed from interfering with the twisting unit 254.

The feeding unit 250 comprises the feeding motor 256. The rebar tying tool 202 further comprises the second connecting cable 266 that electrically connects the feeding motor 256 and the controller 220. The feeding unit 250 is disposed downward than the twisting unit 254. The second connecting cable 266 extends from the feeding motor 256 to the battery receptacle 208 via the coupler 209. In the above configuration, the second connecting cable 266 extending from the feeding motor 256 to the battery receptacle 208 can be arranged without extending it through the twisting unit 254. Thus, the second connecting cable 266 can be suppressed from interfering with the twisting unit 254.

The rebar tying tool 202 further comprises: the magnetic sensor 242a configured to detect a rotation of the reel 232 around which the wire W is wound; and the third connecting cable 244 that electrically connects the magnetic sensor 242a and the controller 220. The magnetic sensor 242a is disposed downward than the twisting unit 254. As shown in FIG. 10, the third connecting cable 244 extends from the magnetic sensor 242a to the battery receptacle 208 via the coupler 209. In the above configuration, the third connecting cable 244 extending from the magnetic sensor 242a to the battery receptacle 208 can be arranged without extending it through the twisting unit 254. Thus, the third connecting cable 244 can be suppressed from interfering with the twisting unit 254.

In the present embodiment, the rebar tying tool 202 is configured to tie the rebars R with the wire W. The rebar tying tool 202 comprises: the feeding unit 250 configured to feed the wire W around the rebars R; the twisting unit 254 configured to retain and twist the wire W around the rebars R; the main body 204 configured to accommodate the feeding unit 250 and the twisting unit 254; arid the contacting member 458 disposed in front of the twisting unit 254 and configured to come into contact with the rebars R upon a tying operation. The contacting position GP at Which the contacting member 458 comes into contact with the rebars R and the retaining position at which the twisting unit 254 retains the wire W are configured to move relative to each other in directions separating away from one another in the state where the twisting unit 254 is retaining the wire W In the above configuration, in the state where the twisting unit 254 is retaining the wire W, the wire W is pulled when the contacting position CP and the retaining position move relative to each other in the directions separating away from one another. As a result, the wire W can be suppressed from being twisted in a state where the wire W is loosened. Due to this, tying force of the wire W on the rebars R can be increased.

In the state where the twisting unit 254 is retaining the wire W, the contacting position CP is configured to move frontward with respect to the main body 204. In the above configuration, by moving the contacting position CP frontward with respect to the main body 204, the contacting position CP and the retaining position can be moved relative to each other in directions separating away from one another.

The rebar tying tool 202 further comprises the pushing part 460 configured to push the contacting member 458 frontward with respect to the main body 204. In the above configuration, by pushing the contacting member 458 frontward with respect to the main body 204 using the pushing part 460. the contacting position CP and the retaining position can be moved relative to each other in directions separating away from one another.

As shown in FIG. 30, the pushing part 460 comprises; the front push rods 492. 496 disposed facing the contacting member 458 behind the contacting member 458 and configured to move in the front-rear direction with respect to the main body 204; the rear push rods 494, 498 disposed facing the front push rods 492, 496 behind the front push rods 492, 496 and configured to move in the front-rear direction with respect to the main body 204; and the first compression springs 504, 506 coupling the front push rods 492, 496 and the rear push rods 494, 498. In the above configuration, an excessive load can be suppressed from being applied to the contacting member 458 by contraction of the first compression springs 504, 506, and the rebar tying tool 202 can be suppressed from being damaged.

The pushing part 460 further comprises the push plate 476 disposed facing the rear push rods 494, 498 behind the rear push rods 494, 498 and configured to move in the front-rear direction with respect to the main body 204. The push plate 476 is configured to move frontward with respect to the main body 204 following a motion of the twisting unit 254. In the above configuration, the rear push rods 494, 498 move frontward with respect to the main body 204 by the push plate 476 pushing the rear push rods 494, 498 frontward. Due to this, the contacting member 458 can be pushed frontward with respect to the main body 204 following the motion of the twisting unit 254.

As shown in FIG. 27, the push plate 476 comprises the recesses 514, 516 into which the rear ends of the rear push rods 494, 498 enter at the positions of the push plate 476 facing the rear push rods 494, 498. In the above configuration, the positions of the rear push rods 494, 498 with respect to the push plate 476 are fixed by the rear ends of the rear push rods 494, 498 entering the recesses 514, 516. Due to this, the rear push rods 494, 498 can stably be moved frontward.

As shown in FIG. 30, the pushing part 460 further comprises the rod guides 500, 502 configured to guide movements of the front push rods 492, 496 and the rear push rods 494, 498. In the above configuration, the front push rods 492, 496 and the rear push rods 494, 498 move in the front-rear direction in the state of being guided by the guide plates 484, 486. Due to this, the front push rods 492, 496 and the rear push rods 494, 498 can stably be moved in the front-rear direction.

The contacting member 458 is supported by the main body 204 pivotably about the pivot axes 466, 468. The rebar tying tool 202 further comprises the torsion springs 470, 472 configured to bias the contacting member 458 with respect to the main body 204 such that the contacting member 458 pivots rearward in a dosing direction with respect to the main body 204 when the contacting member 458 pivoted frontward in an opening direction with respect to the main body 204. In the above configuration, even when the contacting member 458 pivoted frontward in the opening direction, biasing force by the torsion springs 470, 472 is applied to the contacting member 458, and the contacting member 458 can thereby be returned to a state of being closed rearward,

The contacting member 458 comprises: the first contacting part 462 supported by the main body 204 pivotably about the pivot axis 466; and the second contacting part 464 disposed separately from the first contacting part 462 and supported by the main body 204 pivotably about the pivot axis 468. Since the first contacting part 462 and the second contacting part 464 are disposed separately, a load applied from the rebars R to the contacting member 458 can be distributed.

(Corresponding Relationship)

The rear surface 222a is an example of “facing surface”, the accommodating part main body 222 is an example of “facing part”, the battery receptacle 208 is an example of “second accommodating part”, and the magnetic sensor 242a is an example of “detecting sensor”, The front push rods 492, 496 are examples of “first push rod”, the rear push rods 494, 498 are examples of “second push rod”, the first compression springs 504, 506 are examples of “compression spring”, the torsion springs 470, 472 are examples of “biasing member”, the pivot axis 466 is an example of “first pivot axis”, and the pivot axis 468 is an example of “second pivot axis”.

Specific examples of the present invention has been described in detail, however, these are mere exemplary indications and thus do not limit the scope of the claims. The art described in the claims include modifications and variations of the specific examples presented above,

The contacting member 66 according to an aspect may be supported by the main body 4 so as to be movable along the front-rear direction.

The indicator 34 and the adjusting unit 36 according to an aspect may be disposed. traversing over the first rear surface 24a and the second rear surface 24b of the accommodating part main body 18, or may be disposed only on the first rear surface 24a.

The rear surface 24 of the accommodating part main body 18 according to an aspect may comprise a portion that does not overlap with the grip 6 on each of the left and right sides of the grip 6 as the rebar tying tool 2 is viewed from behind.

The rear surface 24 of the accommodating part main body 18 according to an aspect may have the first rear surface 24a that does not overlap with the grip 6 and the second rear surface 24b overlapped with the grip 6 as the rebar tying tool 2 is viewed from behind. In this case, the indicator 34 and the adjusting unit 36 may be disposed traversing over the first rear surface 24a and the second rear surface 24h and be disposed closer toward the first rear surface 24a. Further, the indicator 34 and the adjusting unit 36 may be disposed only on the first rear surface 24a.

The indicator 34 and the adjusting unit 36 according to an aspect may be disposed on the right side surface of the grip 6.

The rebar tying tool 2 according to an aspect may comprise the feeding unit 40 and a pullback unit that are separate from one another. In this case, the pullback unit comprises a motor different from the feeding motor 48.

The contacting member 66 according to an aspect may be composed of an elastic material.

hi this case, when the rebars R come into contact with the contacting member 66, the contacting position between the contacting member 66 and the rebars R moves rearward as the contacting member 66 elastically deforms.

The rebar tying tool 2 according to an aspect may further comprise a second elastic member having a smaller elastic coefficient than the elastic member 68. In this case, the elastic member 68 and the second elastic member may be arranged side by side with each other in the front-rear direction and be interposed between the rear surface of the bent part 76 of the contacting member 66 and the protruding piece 102 of the right main body 4b. Further, the elastic member 68 and the second elastic member may be interposed between the rear surface of the bent part 76 and the protruding piece 102 in a state of being disposed apart from one another in the left-right direction. In the tying operation of the wire W on the rebars R, when the wire W is pulled back from the rebars R, the contacting member 66 may pivot by the second elastic member contracting (elastically deforming), and when the wire W is twisted, the contacting member 66 may pivot by the elastic member 68 contracting (elastically deforming).

The contacting member 66 according to an aspect may come into contact with the rebars

R only at one point.

The front end 80a of the first contacting part 70 and the front end 90a of the second contacting part 72 according to an aspect may not curve in the directions separating away from one another, and may extend linearly frontward.

The first contacting part 70 and the second contacting part 72 according to an aspect may not be coupled., When the contacting member 66 comes into contact with the rebars R, the first contacting part 70 and the second contacting part 72 move independently.

The protrusion 302 according to an aspect may be disposed on the cam part 290. In this case, the recess 292 may be defined in the fixing member 300.

Technical features described in the description and the drawings may technically be useful alone or in various combinations, and are not limited to the combinations as originally claimed. Further, the art described in the description and the drawings may concurrently achieve a plurality of aims, and technical significance thereof resides in achieving any one of such aims.

1. A rebar tying tool configured to tie rebars with a wire, the rebar tying tool comprising:
a feeding unit comprising a feeding roller that is configured to feed the wire around the rebars;
a twisting unit comprising a retaining member that is configured to twist the wire around the rebars;
a grip disposed downward than the twisting unit and configured to be gripped by an operator;
a facing surface disposed frontward than the grip and facing the grip; and
an indicator disposed on the facing surface and configured to indicate a status of the rebar tying tool.

2. The rebar tying tool according to claim 1, further comprising:
an adjusting unit configured to adjust a tying condition of the rebar tying tool,
wherein
the adjusting unit is disposed on the facing surface.

3. The rebar tying tool according to claim 1, wherein the facing surface comprises a first facing surface overlapping with the grip and a second facing surface not overlapping with the grip when the rebar tying tool is viewed from behind, and
at least a part of the indicator is disposed on the second facing surface.

4. The rebar tying tool according to claim 1, wherein the facing surface is disposed on a rear portion of a first accommodating part configured to accommodate a reel around which the wire is wound.

5. The rebar tying tool according to claim 1, further comprising:
a controller electrically connected to the indicator,
wherein
the indicator is disposed downward than the twisting unit and disposed upward than the controller.

6. The rebar tying tool according to claim 5, further comprising:
a facing part disposed downward than the twisting unit, wherein the facing surface is disposed on the facing part;
a second accommodating part disposed downward than the grip and configured to accommodate the controller; and
a first connecting cable that electrically connects the indicator and the controller,
wherein
the facing part is coupled to the second accommodating part via a coupler, and
the first connecting cable extends from the facing part to the second accommodating part via the coupler.

7. The rebar tying tool according to claim 6, wherein the feeding unit comprises a feeding motor,
the rebar tying tool further comprises a second connecting cable that electrically connects the feeding motor and the controller,
the feeding unit is disposed downward than the twisting unit, and
the second connecting cable extends from the feeding motor to the second accommodating part via the coupler.

8. The rebar tying tool according to claim 6, further comprising:
a detecting sensor configured to detect a rotation of a reel around which the wire is wound; and
a third connecting cable that electrically connects the detecting sensor and the controller,
wherein
the detecting sensor is disposed downward than the twisting unit, and
the third connecting cable extends from the detecting sensor to the second accommodating part via the coupler.

9. A rebar tying tool configured to tie rebars with a wire, the rebar tying tool comprising:
a feeding unit comprising a feeding roller that is configured to feed the wire around the rebars;
a twisting unit comprising a retaining member that is configured to twist the wire around the rebars;
a grip disposed downward than the twisting unit and configured to be gripped by an operator; and
an indicator configured to indicate a status of the rebar tying tool,
wherein
a side surface of the grip includes the indicator.

10. The rebar tying tool according to claim 9, further comprising:
a trigger configured to drive the feeding unit and the twisting unit based on an operation by the operator; and
an adjusting unit configured to adjust a tying condition of the rebar tying tool,
wherein
the adjusting unit is disposed near the trigger.

11. The rebar tying tool according to claim 10, wherein the adjusting unit is disposed near the indicator.

12. The rebar tying tool according to claim 10, further comprising:
a trigger lock configured to prohibit an operation of the trigger,
wherein
the trigger lock is disposed near the adjusting unit.
